(19) United States
(12) Patent Application Publication
(10) Pub. No.: US 2023/0141280 A1
(43) Pub. Date: May 11, 2023

(54) SILICONE RUBBER FORMULATIONS COMPRISING SILOXANES BEARING ALICYCLIC SIDE CHAIN GROUPS

(71) Applicant: Apple Inc., Cupertino, CA (US)

(72) Inventors: Andrei Gavryushin, München (DE); Christian Bertl, München (DE); Juergen Sauer, München (DE)

(21) Appl. No.: 17/976,618

(22) Filed: Oct. 28, 2022

Related U.S. Application Data
(60) Provisional application No. 63/273,675, filed on Oct. 29, 2021.

(51) Int. Cl. C08G 77/20; C08L 83/04

(52) U.S. Cl. CPC C08G 77/20; C08L 83/04; C08L 2205/025

(57) ABSTRACT

Cured silicone rubbers for acoustic damping, and formulations and methods used to make the same, are provided.

### PRIORITY

This patent application claims the benefit of U.S. Provisional Patent Application No. 63/273,675, entitled “SILICONE RUBBER FORMULATIONS COMPRISING SILOXANES BEARING ALICYCLIC SIDE GROUPS,” filed on Oct. 29, 2021, which is incorporated herein by reference in its entirety.

### FIELD

This disclosure relates generally to silicone elastomers bearing alicyclic side chain groups, cured silicone rubbers and formulations containing the same.

### BACKGROUND

Silicone elastomers, also known as silicone rubbers, appear frequently in industrial products such as flexible baking molds, bathroom sealants, skin adhesives, cosmetics and noise cancellation for car brakes. Silicone elastomers are also extensively used in advanced technologies, in the form of stretchable electronics, drug delivery vehicles, superhydrophobic surfaces and implants. Such a wide range of application requires silicone elastomers with diverse properties.

In an audio speaker design, membrane materials able to damp particular frequencies can be included as speaker components. Speakers can show unfavorable oscillation modes of the diaphragm, leading to a distorted acoustic output. A reduction of their amplitudes by damping improves therefore the quality of the sound.

In silicone rubbers, an increased damping coefficient (tan δ) is can be changed, or “tuned” by the addition of filler materials such as, for example, carbon black, fumed silica, titanium dioxide. These filler materials do not allow for damping properties to be tuned with precision. For several applications in electronic devices, it is highly desirable to use silicone rubbers that exhibit damping coefficients higher than 0.3.

In particular, a high loss factor is favorable when unwanted oscillations must be suppressed or if a resonance should be flattened. Loudspeakers can show unfavorable oscillation modes of the diaphragm, leading to a distorted acoustic output. Suppression of these undesirable modes by damping significantly improves the quality of sound. Tan δ values higher than 0.3 are hardly achievable by simple addition of standard filler materials.

### SUMMARY

In a first aspect, the disclosure is directed to a compound having the structure of Formula (I):

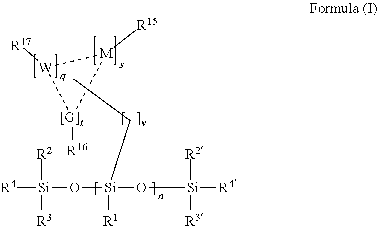

wherein

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, and substituted heteroalkyl;

each of R³ and R^{3′} is independently selected from hydrogen, alkyl, substituted alkyl, heteroalkyl, and substituted heteroalkyl;

each of R⁴ and R^{4′} is a reactive group;

each of R¹⁵, R¹⁶, and R¹⁷ is each independently selected from hydrogen, alkyl, non-aryl substituted alkyl, heteroalkyl, non-aryl substituted heteroalkyl, or two of R¹⁵, R¹⁶, and R¹⁷ together with the carbon atom to which they are bonded form a cycloalkyl, non-aryl substituted cycloalkyl, cycloheteroalkyl, or non-aryl substituted cycloheteroalkyl ring;

in the G-M-W side group:

G is selected from alkyl, non-aryl substituted alkyl, heteroalkyl, and non-aryl substituted heteroalkyl;

M is selected from alkyl, non-aryl substituted alkyl, heteroalkyl, and non-aryl substituted heteroalkyl;

W is selected from alkyl, non-aryl substituted alkyl, heteroalkyl, and non-aryl substituted heteroalkyl;

n is an integer between 5 and 10000;

q is an integer between 1 and 10;

s is an integer between 1 and 10;

t is an integer between 1 and 10; and

v is an integer between 0 and 6.

In a second aspect, the disclosure is directed to a compound having the structure of Formula (II):

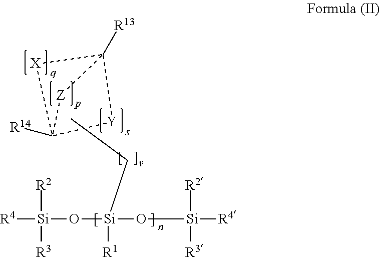

wherein

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, and substituted heteroalkyl;

each of R³ and R^{3′} is independently selected from hydrogen, alkyl, substituted alkyl, heteroalkyl, and substituted heteroalkyl;

each of R⁴ and R^{4′} is independently a reactive group;

in the X-Y-Z side group:

X is selected from alkyl, non-aryl substituted alkyl, heteroalkyl, and non-aryl substituted heteroalkyl;

Y is selected from alkyl, non-aryl substituted alkyl, heteroalkyl, and non-aryl substituted heteroalkyl;

Z is selected from alkyl, non-aryl substituted alkyl, heteroalkyl, and non-aryl substituted heteroalkyl;

or two of X, Y, or Z together with the carbon atom to which they are bonded form a cycloalkyl, non-aryl substituted cycloalkyl, cycloheteroalkyl, or non-aryl substituted cycloheteroalkyl ring;

n is an integer between 5 and 10000;

q is an integer between 1 and 10;

p is an integer between 1 and 10;

s is an integer between 1 and 10; and

v is an integer between 0 and 6.

In a third aspect, the disclosure is directed to a compound of Formula (III):

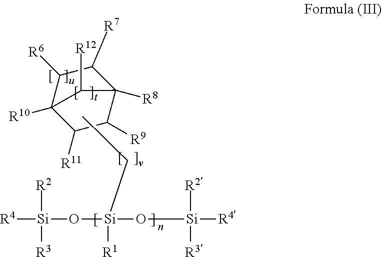

wherein

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, and substituted heteroalkyl;

each of R³ and R^{3′} is independently selected from hydrogen, alkyl, substituted alkyl, heteroalkyl, and substituted heteroalkyl;

each of R⁴ and R^{4′} is independently a reactive group;

in the side group, each of R⁶, R⁷, R⁸, R⁹, R¹⁰, R¹¹, and R¹² is each independently selected from hydrogen, alkyl, non-aryl substituted alkyl, heteroalkyl, and non-aryl substituted heteroalkyl;

n is an integer between 5 and 10000;

u is an integer between 1 and 20;

t is an integer between 1 and 10; and

v is an integer between 0 and 6.

The disclosure is further directed to cured silicone rubbers comprising the compounds herein, formulations comprising the compounds herein, methods of making silicone robbers, and devices containing the same.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1A depicts the tangent of the loss angle (tan δ) as a function of temperature of four silicone rubbers that contain 20% of polysiloxane polymers 1, 2, 11, and 13 in Table 1, according to illustrative embodiments;

FIG. 1B depicts the storage modulus as a function of temperature of four silicone rubbers that contain 20% of siloxane polymers 1, 2, 11, and 13 in Table 1, according to illustrative embodiments;

FIG. 2A depicts the tangent of the loss angle (tan δ) as a function of frequency of a silicone rubbers that contain 20% of siloxane polymer 11 in Table 1, according to an illustrative embodiment;

FIG. 2B depicts the storage modulus as a function of frequency of a silicone rubbers that contain 20% of siloxane polymer 11 in Table 1, according to an illustrative embodiment;

FIG. 3A depicts a 5,000× scanning electron micrograph (SEM) images of cross sectional cuts of sample 11, according to an illustrative embodiment. The SEM image includes both dark and light spots. The preparation of the samples is described in Examples;

FIG. 3B depicts a 10,000× scanning electron micrograph (SEM) images of cross sectional cuts of sample 11, according to an illustrative embodiment. The SEM image includes both dark and light spots. The preparation of the samples is described in Examples;

FIG. 4 illustrates an expanded view of the IR spectrum of the compound of sample 11 from wavelengths 1000 cm⁻¹ to 400 cm⁻¹, according to an illustrative embodiment; and

FIG. 5 illustrates a cross-sectional view of a speaker, in accordance with various illustrative embodiments.

### DETAILED DESCRIPTION

The disclosure is directed to cured silicone rubber materials with high damping properties. The cured silicone rubber materials can be configured to damp particular acoustic frequencies or ranges of frequencies, and possess a defined maximum on the frequency-damping curve, in some instances in the frequency range 0.5-30000 Hz at temperatures 0-50° C. In other variations, the cured silicon rubber materials possess a defined maximum on a frequency-damping curve, in some instances in the frequency range of 20 Hz-5000 Hz at temperatures 0-50° C.

Damping can be described as the loss factor equal to the tangent of the loss angle (tan δ). The loss factor characterizes the ratio between dissipated energy and stored energy during one oscillation cycle. A high loss factor is favorable when unwanted oscillations are suppressed, or if a resonance is flattened.

The cured silicone rubbers have a tan δ peak in a desired frequency range, and low temperature maximum (e.g. less than or equal to 5° C., less then or equal to 0° C.) of tan δ at that frequency range, and temperature stable polymer substituents.

The cured silicone rubber can be prepared by a quick curing process at ambient temperature, without requiring complex heating/cooling machinery and/or prolonged time. Curing isothermally at ambient temperature can also reduce variations in properties of the silicone rubber due to temperature differences.

### Definitions

“Alkyl” by itself or as part of another substituent refers to a saturated or unsaturated, branched, straight-chain or cyclic monovalent hydrocarbon radical derived by the removal of one hydrogen atom from a single carbon atom of a parent alkane, alkene or alkyne. Typical alkyl groups include, but are not limited to, methyl; ethyls such as ethanyl, ethenyl, ethynyl; propyls such as propan-1-yl, propan-2-yl, cyclopropan-1-yl, prop-1-en-1-yl, prop-1-en-2-yl, prop-2-en-1-yl (allyl), cycloprop-1-en-1-yl; cycloprop-2-en-1-yl, prop-1-yn-1-yl, prop-2-yn-1-yl, etc.; butyls such as butan-1-yl, butan-2-yl, 2-methyl-propan-1-yl, 2-methyl-propan-2-yl, cyclobutan-1-yl, but-1-en-1-yl, but-1-en-2-yl, 2-methyl-prop-1-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, but-1-yn-1-yl, but-1-yn-3-yl, but-3-yn-1-yl, etc.; and the like. The term “alkyl” is specifically intended to include groups having any degree or level of saturation, i.e., groups having exclusively single carbon-carbon bonds, groups having one or more double carbon-carbon bonds, groups having one or more triple carbon-carbon bonds and groups having mixtures of single, double and triple carbon-carbon bonds. Where a specific level of saturation is intended, the expressions “alkanyl,” “alkenyl,” and “alkynyl” are used. In some variations, an alkyl group comprises from 1 to 20 carbon atoms; in some variations, from 1 to 10 carbon atoms, in some variations, 1 to 6 carbon atoms. “C₁₋₆ alkyl” refers to an alkyl group containing from 1 to 6 carbon atoms.

“Alkanyl” by itself or as part of another substituent refers to a saturated branched, straight-chain or cyclic alkyl radical derived by the removal of one hydrogen atom from a single carbon atom of a parent alkane. Typical alkanyl groups include, but are not limited to, methanyl; ethanyl; propanyls such as propan-1-yl, propan-2-yl (isopropyl), cyclopropan-1-yl, etc.; butanyls such as butan-1-yl, butan-2-yl (sec-butyl), 2-methyl-propan-1-yl (isobutyl), 2-methyl-propan-2-yl (tert-butyl), cyclobutan-1-yl, etc.; and the like.

“Alkenyl” by itself or as part of another substituent refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Typical alkenyl groups include, but are not limited to, ethenyl; propenyls such as prop-1-en-1-yl, prop-1-en-2-yl, prop-2-en-1-yl (allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl, but-2-en-1-yl, but-2-en-2-yl, buta-1,3-dien-1-yl, buta1,3-dien-2-yl, cyclobut-1-en-1-yl, cyclobut-1-en-3-yl, cyclobuta-1,3-dien-1-yl, etc.; and the like.

“Alkynyl” by itself or as part of another substituent refers to an unsaturated branched, straight-chain or cyclic alkyl radical having at least one carbon-carbon triple bond derived by the removal of one hydrogen atom from a single carbon atom of a parent alkyne. Typical alkynyl groups include, but are not limited to, ethynyl; propynyls such as prop-1-yn-1-yl, prop-2-yn-1-yl, etc.; butynyls such as but-1-yn-1-yl, but-1-yn-3-yl, but-3-yn-1-yl, etc.; and the like.

“Aryl” by itself or as part of another substituent refers to a monovalent aromatic hydrocarbon radical derived by the removal of one hydrogen atom from a single carbon atom of a parent aromatic ring system. Aryl encompasses 5- and 6-membered carbocyclic aromatic rings, for example, benzene; bicyclic ring systems wherein at least one ring is carbocyclic and aromatic, for example, naphthalene, indane, and tetralin; and tricyclic ring systems wherein at least one ring is carbocyclic and aromatic, for example, fluorene. Aryl encompasses multiple ring systems having at least one carbocyclic aromatic ring fused to at least one carbocylic aromatic ring, cycloalkyl ring, or heterocycloalkyl ring. For example, aryl includes 5- and 6-membered carbocyclic aromatic rings fused to a 5- to 7-membered heterocycloalkyl ring containing one or more heteroatoms chosen from N, O, and S. For such fused, bicyclic ring systems wherein only one of the rings is a carbocyclic aromatic ring, the point of attachment may be at the carbocyclic aromatic ring or the heterocycloalkyl ring. Examples of aryl groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene. In certain embodiments, an aryl group may have from 5 to 20 carbon atoms, and in certain embodiments, from 5 to 12 carbon atoms. Aryl, however, does not encompass or overlap in any way with heteroaryl, separately defined herein. Hence, a multiple ring system in which one or more carbocyclic aromatic rings is fused to a heterocycloalkyl aromatic ring, is heteroaryl, not aryl, as defined herein. In certain embodiments, aryl is C6-10 aryl or phenyl.

“Arylalkyl” by itself or as part of another substituent refers to an acyclic alkyl radical in which one of the hydrogen atoms bonded to a carbon atom, typically a terminal or sp3 carbon atom, is replaced with an aryl group. Examples of arylalkyl groups include, but are not limited to, benzyl, 2-phenylethan-1-yl, 2-phenylethen-1-yl, naphthylmethyl, 2-naphthylethan-1-yl, 2-naphthylethen-1-yl, naphthobenzyl, 2-naphthophenylethan-1-yl. Where specific alkyl moieties are intended, the nomenclature arylalkanyl, arylalkenyl, or arylalkynyl is used. In certain embodiments, an arylalkyl group is C7-30 arylalkyl, e.g., the alkanyl, alkenyl, or allcynyl moiety of the arylalkyl group is C1-10 and the aryl moiety is C6-20, and in certain embodiments, an arylalkyl group is C7-20 arylalkyl, e.g., the alkanyl, alkenyl, or alkynyl moiety of the arylalkyl group is C1-8 and the aryl moiety is C6-12. In certain embodiments, arylalkyl is C7-16 arylalkyl or benzyl.

“Cycloalkyl” by itself or as part of another substituent refers to a saturated or unsaturated cyclic alkyl radical, including one or more cyclic alkyl structures. Where a specific level of saturation is intended, the nomenclature “cycloalkanyl” or “cyclo alkenyl” is used. Typical cycloalkyl groups include, but are not limited to, groups derived from cyclopropane, cyclobutane, cyclopentane, cyclohexane, bicycloheptane, bicyclooctane, tricyclodecane and the like.

“Cycloheteroalkyl” by itself or as part of another substituent refers to a saturated or unsaturated cyclic alkyl radical including one or more cyclic structures in which one or more carbon atoms (and any associated hydrogen atoms) are independently replaced with the same or different heteroatom. Typical heteroatoms to replace the carbon atom(s) include, but are not limited to, N, P, O, S, Si, etc. Where a specific level of saturation is intended, the nomenclature “cycloheteroalkanyl” or “cycloheteroalkenyl” is used. Typical cycloheteroalkyl groups include, but are not limited to, groups derived from epoxides, azirines, thiiranes, tetrahydrofuran, tetrahydropyran, imidazolidine, morpholine, piperazine, piperidine, pyrazolidine, pyrrolidine, quinuclidine and the like.

“Heteroalkyl”, “Heteroalkanyl”, “Heteroalkenyl”, and “Heteroalkynyl” by themselves or as part of another substituent refer to alkyl, alkanyl, alkenyl and alkynyl groups, respectively, in which one or more of the carbon atoms (and any associated hydrogen atoms) are independently replaced with the same or different heteroatomic groups. Typical heteroatomic groups which can be included in these groups include, but are not limited to, —O—, —S—, —O—O—, —S—S—, —O—S—, —NR³⁴R³⁵—, ═N—N═, —N═N—, —N═N—NR³⁶R³⁷, —PR³⁸—, —P(O)₂—, —POR³⁹—, -0-P(O)₂—, —SO—, —SO₂—, —SnR⁴⁰R⁴¹— and the like, where R³⁴, R³⁵, R³⁶, R³⁷, R³⁸, R³⁹, R⁴⁰ and R⁴¹ are independently hydrogen, alkyl, substituted alkyl, aryl, substituted aryl, arylalkyl, substituted arylalkyl, cycloalkyl, substituted cycloalkyl, cycloheteroalkyl, substituted cyclohetero alkyl, heteroalkyl, substituted heteroalkyl, heteroaryl, substituted heteroaryl, heteroarylalkyl or substituted heteroarylalkyl. In the case of a non-aryl substituted heteroalkyl, R³⁴, R³⁵, R³⁶, R³⁷, R³⁸, R³⁹, R⁴⁰ and R⁴¹ are independently hydrogen, alkyl, non-aryl substituted alkyl, heteroalkyl, and non-aryl substituted heteroalkyl.

“Heteroaryl” by itself or as part of another substituent refers to a monovalent heteroaromatic radical derived by the removal of one hydrogen atom from a single atom of a parent heteroaromatic ring system. Heteroaryl encompasses multiple ring systems having at least one aromatic ring fused to at least one other ring, which may be aromatic or non-aromatic in which at least one ring atom is a heteroatom. Heteroaryl encompasses 5- to 7-membered aromatic, monocyclic rings containing one or more, for example, from 1 to 4, or in certain embodiments, from 1 to 3, heteroatoms chosen from N, O, and S, with the remaining ring atoms being carbon; and bicyclic heterocycloalkyl rings containing one or more, for example, from 1 to 4, or in certain embodiments, from 1 to 3, heteroatoms chosen from N, O, and S, with the remaining ring atoms being carbon and wherein at least one heteroatom is present in an aromatic ring. For example, heteroaryl includes a 5- to 7-membered heterocycloalkyl, aromatic ring fused to a 5- to 7-membered cycloalkyl ring. For such fused, bicyclic heteroaryl ring systems wherein only one of the rings contains one or more heteroatoms, the point of attachment may be at the heteroaromatic ring or the cycloalkyl ring. In certain embodiments, when the total number of N, S, and O atoms in the heteroaryl group exceeds one, the heteroatoms are not adjacent to one another, hi certain embodiments, the total number of N, S, and O atoms in the heteroaryl group is not more than two. In certain embodiments, the total number of N, S, and O atoms in the aromatic heterocycle is not more than one. Heteroaryl does not encompass or overlap with aryl as defined herein. Examples of heteroaryl groups include, but are not limited to, groups derived from acridine, arsindole, carbazole, β-carboline, chromane, cliromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene. In certain embodiments, a heteroaryl group is from 5- to 20-membered heteroaryl, and in certain embodiments from 5- to 10-membered heteroaryl. In certain embodiments heteroaryl groups are those derived from thiophene, pyrrole, benzothiophene, benzofuran, indole, pyridine, quinoline, imidazole, oxazole, and pyrazine.

“Heteroarylalkyl” by itself or as part of another substituent refers to an acyclic alkyl radical in which one of the hydrogen atoms bonded to a carbon atom, typically a terminal or sp³ carbon atom, is replaced with a heteroaryl group. Where specific alkyl moieties are intended, the nomenclature heteroarylalkanyl, heteroarylalkenyl, or heteroarylalkynyl is used. In certain embodiments, a heteroarylalkyl group is a 6- to 30-membered heteroarylalkyl, e.g., the alkanyl, alkenyl, or alkynyl moiety of the heteroarylalkyl is 1- to 10-membered and the heteroaryl moiety is a 5- to 20-membered heteroaryl, and in certain embodiments, 6-to 20-membered heteroarylalkyl, e.g., the alkanyl, alkenyl, or alkynyl moiety of the heteroarylalkyl is 1- to 8-membered and the heteroaryl moiety is a 5- to 12-membered heteroaryl.

“Reactive Group” refers to a group that can react with other chemical compositions. In some variations, the reactive group includes one or more unsaturated moieties. The unsaturated moieties are suitable for polymerization reaction, and can include, but are not limited to, vinyl, allyl, 4-buten-1-yl, 11-undecen-1-yl, 2-methacryloyloxyethyl, 2-(5-norborn-2-enyl)ethyl, etc. In some variations, the unsaturated moiety is a vinyl moiety or 2-(5-norborn-2-enyl)ethyl moiety.

“Substituted” refers to a group in which one or more hydrogen atoms are independently replaced with the same or different substituent(s). Example of substituents include, but are not limited to, -M, -R⁶⁰, —O″(—OH), =0, —OR⁶⁰, —SR⁶⁰, —S—(—SH), ═S, —NR⁶⁰R⁶¹, ═NR⁶⁰, —CF₃, —CN, —OCN, —SCN, —NO, —NO₂, —N₂, —N₃, —S(O)₂O″, —S(O)₂OH, —S(O)₂R⁶⁰, —OS(O₂)O″, —OS(O)₂R⁶⁰, —P(O)(OO₂, —P(O)(OR⁶⁰XO—), —OP(OXOR⁶⁰XOR⁶¹), —C(O)R⁶⁰, —C(S)R⁶⁰, —C(O)OR⁶⁰, —C(O)NR⁶⁰R⁶¹, —C(O)O″, —C(S)OR⁶⁰, —NR⁶²C(O)NR⁶⁰R⁶¹, —NR⁶²C(S)NR⁶⁰R⁶¹, —NR⁶²C(NR⁶³)NR⁶⁰R⁶¹ and —C(NR⁶²)NR⁶⁰R⁶¹ where M is a halogen; R⁶⁰, R⁶¹, R⁶², and R⁶³ are independently selected from hydrogen, alkyl, substituted alkyl, alkoxy, substituted alkoxy, cycloalkyl, substituted cycloalkyl, cycloheteroalkyl, substituted cycloheteroalkyl, aryl, substituted aryl, heteroaryl, and substituted heteroaryl, or when bonded to a nitrogen atom, R⁶⁰ and R⁶¹ together with the nitrogen atom to which they are bonded form a cycloheteroalkyl or substituted cycloheteroalkyl ring; and R⁶² and R⁶³ are independently selected from hydrogen, alkyl, substituted alkyl, aryl, cycloalkyl, substituted cycloalkyl, cycloheteroalkyl, substituted cycloheteroalkyl, aryl, substituted aryl, heteroaryl, and substituted heteroaryl, or when bonded to a nitrogen atom, R⁶² and R⁶³ together with the nitrogen atom to which they are bonded form a cycloheteroalkyl or substituted cycloheteroalkyl ring, hi certain embodiments, substituents include -M, -R⁶⁰, =0, —OR⁶⁰, —SR⁶⁰, —S″, ═S, —NR⁶⁰R⁶¹, ═NR⁶⁰, —CF₃, —CN, —OCN, —SCN, —NO, —NO₂, ═N₂, —N₃, —S(O)₂R⁶⁰, —OS(O₂)O″, —OS(O)₂R⁶⁰, —P(0)(0″)₂, —P(O)(OR⁶⁰)(O″), —OP(O)(OR⁶⁰XOR⁶¹), —C(O)R⁶⁰, —C(S)R⁶⁰, —C(O)OR⁶⁰, —C(O)NR⁶⁰R⁶¹, —C(O)O″, and —NR⁶²C(O)NR⁶⁰R⁶¹, where R⁶⁰, R⁶¹, and R⁶² are as defined above. In other embodiments, substituents may be chosen from -M, -R⁶⁰, =0, —OR⁶⁰, —SR⁶⁰, —NR⁶⁰R⁶¹, —CF₃, —CN, —NO₂, —S(O)₂R⁶⁰, —P(O)(OR⁶⁰)(O″), —OP(O)(OR^{&υ})(OR⁶¹), —C(O)R⁶⁰, —C(O)OR⁶⁰, —C(O)NR⁶⁰R⁶¹, —C(O)O; where R⁶⁰ and R⁶¹ are as defined above. In yet other embodiments, substituents include -M, -R⁶⁰, =0, —OR⁶⁰, —SR⁶⁰, —NR⁶⁰R⁶¹, —CF₃, —CN, —NO₂, —S(O)₂R⁶⁰, —OP(O)(OR⁶⁰)(OR⁶¹), —C(O)R⁶⁰, —C(O)OR⁶⁰, and —C(O)O″, where R⁶⁰ and R⁶¹ are as defined above. In certain embodiments, each substituent is independently selected from C₁₋₃ alkyl, —OH, —NH₂, —SH, C₁₋₃ alkoxy, C₁₋₃ acyl, C₁₋₃ thioalkyl, C₁₋₃ alkoxycarbonyl, C₁₋₃ alkylarnino, and C₁₋₃ dialkylamino, as defined herein.

“Non-aryl substituted” refers to a group in which one or more hydrogen atoms are independently replaced with the same or different substituent(s) and does not include aryl, heteroaryl, or heteroaryl alkyl groups.

“Aryl Substituted” refers to a group in which one or more hydrogen atoms are independently replaced with the same or different substituent(s) that include at least one aryl, heteroaryl, or heteroaryl alkyl group.

### Side Group Modified Siloxane Polymers

The disclosure is directed to siloxanes with a modified siloxane backbone. The siloxanes described herein are referred to as side group modified (“SGM”) siloxanes or SGM polymers. In various aspects, the silicone rubbers having cyclic alkane side groups, and alicyclic alkanes as side groups provided a significant increase of damping properties.

In one variation, the disclosure is direct to a siloxane polymer according to the structural Formula (I):

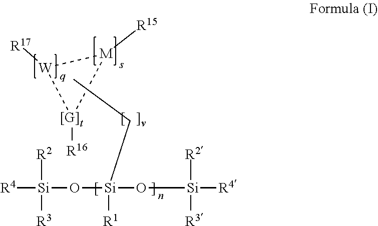

wherein

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, substituted heteroalkyl, aryl, or substituted aryl;

each of R³ and R^{3′} is independently selected from hydrogen, alkyl, substituted alkyl, heteroalkyl, and substituted heteroalkyl, aryl, or substituted aryl;

each of R⁴ and R^{4′} is independently a reactive group;

each of R¹⁵, R¹⁶, and R¹⁷ is each independently selected from hydrogen, alkyl, non-aryl substituted alkyl, heteroalkyl, non-aryl substituted heteroalkyl, or two of R¹⁵, R¹⁶, and R¹⁷ together with the carbon atom to which they are bonded form a cycloalkyl, non-aryl substituted cycloalkyl, cycloheteroalkyl, or non-aryl substituted cycloheteroalkyl ring;

in the G-M-W side group:

G is selected from alkyl, non-aryl substituted alkyl, heteroalkyl, and non-aryl substituted heteroalkyl;

M is selected from alkyl, non-aryl substituted alkyl, heteroalkyl, and non-aryl substituted heteroalkyl;

W is selected from alkyl, non-aryl substituted alkyl, heteroalkyl, and non-aryl substituted heteroalkyl;

n is an integer between 5 and 10000;

q is an integer between 1 and 10;

s is an integer between 1 and 10;

t is an integer between 1 and 10; and

v is integer between 0 and 6.

In some variations, R¹ is selected from hydrogen, alkyl, and non-aryl substituted alkyl. In some variations, R¹ is selected from C₁-C₆ alkyl and C₁-C₆ non-aryl substituted alkyl. In some variations, R¹ is C₁-C₆ alkyl. In some variations, R¹ is methyl.

In some variations, each of R² and R^{2′} is independently selected from hydrogen, C₁-C₆ alkyl, substituted C₁-C₆ alkyl, C₁-C₆ heteroalkyl, and substituted C₁-C₆ heteroalkyl, C₁-C₆ aryl, or substituted C₁-C₆ aryl. In some variations, each of R² and R^{2′} is independently selected from C₁-C₆ alkyl, substituted C₁-C₆ alkyl, C₁-C₆ heteroalkyl, and substituted C₁-C₆ heteroalkyl. In some variations, each of R² and R^{2′} is independently selected from C₁-C₆ alkyl and substituted C₁-C₆ alkyl.

In some variations, each of R² and R^{2′} is independently C₁-C₆ alkyl. In some variations, each of R² and R^{2′} is methyl.

In some variations, each of R³ and R^{3′} is independently selected from hydrogen, alkyl, substituted alkyl, heteroalkyl, substituted heteroalkyl, C₁-C₆ aryl or substituted C₁-C₆ aryl. In some variations, each of R³ and R^{3′} is independently selected from alkyl, substituted alkyl, heteroalkyl, and substituted heteroalkyl. In some variations, each of R³ and R^{3′} is independently selected from C₁-C₆ alkyl, substituted C₁-C₆ alkyl, C₁-C₆ heteroalkyl, substituted C₁-C₆ heteroalkyl, C₁-C₆ aryl or substituted C₁-C₆ aryl. In some variations, each of R³ and R^{3′} is independently selected from C₁-C₆ alkyl and substituted C₁-C₆ alkyl. In some variations, each of R³ and R^{3′} is independently C₁-C₆ alkyl. In some variations, each of R³ and R^{3′} is methyl.

In some variations, each of R⁴ and R^{4′} is a vinyl substituent.

In some variations, each of R¹⁵, R¹⁶, and R¹⁷ is independently selected from hydrogen, alkyl, non-aryl substituted alkyl, heteroalkyl, non-aryl substituted heteroalkyl, or two of R¹⁵, R¹⁶, and R¹⁷ together with the carbon atom to which they are bonded form a cycloalkyl, non-aryl substituted cycloalkyl, cycloheteroalkyl, or non-aryl substituted cycloheteroalkyl ring. In some variations, each of R¹⁵, R¹⁶, and R¹⁷ is independently selected from C₁-C₂₀ alkyl, non-aryl substituted C₁-C₂₀ alkyl, C₁-C₂₀ heteroalkyl, and non-aryl substituted C₁-C₂₀ heteroalkyl, or two of R¹⁵, R¹⁶, and R¹⁷ together with the carbon atom to which they are bonded form a C₁-C₄₀ cycloalkyl, C₁-C₄₀ non-aryl substituted cycloalkyl, C₁-C₄₀ cycloheteroalkyl, or non-aryl substituted C₁-C₄₀ cycloheteroalkyl ring.

In some variations, n is at least 5. In some variations, n is at least 50. In some variations n is at least 100. In some variations, n is at least 150. In some variations, n is at least 200. In some variations, n is at least 250. In some variations, n is equal to or less than 1000. In some variations, n is equal to or less than 800. In some variations, n is equal to or less than 600. In some variations, n is equal to or less than 500. In some variations, n is equal to or less than 400. In some variations, n is equal to or less than 300. In some variations, n is equal to or less than 250. In some variations, n is equal to or less than 200.

In some variations, q is an integer greater than or equal to 1. In some variations, q is an integer greater than or equal to 2. In some variations, q is an integer greater than or equal to 3. In some variations, q is an integer greater than or equal to 4. In some variations, q is an integer greater than or equal to 5. In some variations, q is an integer greater than or equal to 6. In some variations, q is an integer greater than or equal to 7. In some variations, q is an integer greater than or equal to 8. In some variations, q is an integer greater than or equal to 9. In some variations, q is an integer less than or equal to 10. In some variations, q is an integer less than or equal to 10. In some variations, q is an integer less than or equal to 9. In some variations, q is an integer less than or equal to 8. In some variations, q is an integer less than or equal to 7. In some variations, q is an integer less than or equal to 6. In some variations, q is an integer less than or equal to 5. In some variations, q is an integer less than or equal to 4. In some variations, q is an integer less than or equal to 3. In some variations, q is an integer less than or equal to 2.

In some variations, p is an integer greater than or equal to 1. In some variations, p is an integer greater than or equal to 2. In some variations, p is an integer greater than or equal to 3. In some variations, p is an integer greater than or equal to 4. In some variations, p is an integer greater than or equal to 5. In some variations, p is an integer greater than or equal to 6. In some variations, p is an integer greater than or equal to 7. In some variations, p is an integer greater than or equal to 8. In some variations, p is an integer greater than or equal to 9. In some variations, p is an integer less than or equal to 10. In some variations, p is an integer less than or equal to 10. In some variations, p is an integer less than or equal to 9. In some variations, p is an integer less than or equal to 8. In some variations, p is an integer less than or equal to 7. In some variations, p is an integer less than or equal to 6. In some variations, p is an integer less than or equal to 5. In some variations, p is an integer less than or equal to 4. In some variations, p is an integer less than or equal to 3. In some variations, p is an integer less than or equal to 2.

In some variations, s is an integer greater than or equal to 1. In some variations, s is an integer greater than or equal to 2. In some variations, s is an integer greater than or equal to 3. In some variations, s is an integer greater than or equal to 4. In some variations, s is an integer greater than or equal to 5. In some variations, s is an integer greater than or equal to 6. In some variations, s is an integer greater than or equal to 7. In some variations, s is an integer greater than or equal to 8. In some variations, s is an integer greater than or equal to 9. In some variations, s is an integer less than or equal to 10. In some variations, s is an integer less than or equal to 10. In some variations, s is an integer less than or equal to 9. In some variations, s is an integer less than or equal to 8. In some variations, s is an integer less than or equal to 7. In some variations, s is an integer less than or equal to 6. In some variations, s is an integer less than or equal to 5. In some variations, s is an integer less than or equal to 4. In some variations, s is an integer less than or equal to 3. In some variations, s is an integer less than or equal to 2.

In some variations, v is integer between 0 and 3. In some variations, v is integer between 1 and 6. In some variations, v is 0. In some variations, v is 1. In some variations, v is 2. In some variations, v is 3. In some variations, v is 4. In some variations, v is 5. In some variations, v is 6.

The variables in Formula (I) can be combined with other variable in Formula (I) in any combination. In some variations, the G-M-W substituent, the alicyclic side groups can be the same or different within a single SGM polymer. In some variations, the G-M-W substituent can be a terpenyl radical.

In another variation, the disclosure is directed to a siloxane polymer according to the structural Formula (II):

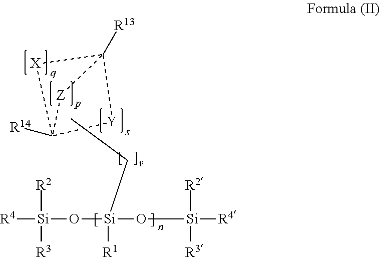

wherein

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, substituted heteroalkyl, aryl, and substituted aryl;

each of R³ and R^{3′} is independently selected from hydrogen, alkyl, substituted alkyl, heteroalkyl, substituted heteroalkyl, aryl, and substituted aryl;

each of R⁴ and R^{4′} is independently a reactive group;

X is selected from alkyl, non-aryl substituted alkyl, heteroalkyl, and non-aryl substituted heteroalkyl;

Y is selected from alkyl, non-aryl substituted alkyl, heteroalkyl, and non-aryl substituted heteroalkyl;

Z is selected from alkyl, non-aryl substituted alkyl, heteroalkyl, and non-aryl substituted heteroalkyl;

or two of X, Y, or Z together with the carbon atom to which they are bonded form a cycloalkyl, non-aryl substituted cycloalkyl, cycloheteroalkyl, or non-aryl substituted cycloheteroalkyl ring;

n is an integer between 5 and 10000;

q is an integer between 1 and 10;

p is an integer between 1 and 10;

s is an integer between 1 and 10; and

v is an integer between 0 and 6.

In some variations, R¹ is selected from alkyl and non-aryl substituted alkyl. In some variations, R¹ is selected from C₁-C₆ alkyl and C₁-C₆ non-aryl substituted alkyl. In some variations, R¹ is C₁-C₆ alkyl. In some variations, R¹ is methyl.

In some variations, each of R² and R^{2′} is independently selected from alkyl, substituted alkyl, heteroalkyl, and substituted heteroalkyl. In some variations, each of R² and R^{2′} is independently selected from C₁-C₆ alkyl, substituted C₁-C₆ alkyl, C₁-C₆ heteroalkyl, substituted C₁-C₆ heteroalkyl, aryl, and substituted aryl. In some variations, each of R² and R^{2′} is independently selected from C₁-C₆ alkyl and substituted C₁-C₆ alkyl. In some variations, each of R² and R^{2′} is independently C₁-C₆ alkyl. In some variations, each of R² and R^{2′} is methyl.

In some variations, each of R³ and R^{3′} is independently selected from alkyl, substituted alkyl, heteroalkyl, and substituted heteroalkyl. In some variations, each of R³ and R^{3′} is independently selected from C₁-C₆ alkyl, substituted C₁-C₆ alkyl, C₁-C₆ heteroalkyl, substituted C₁-C₆ heteroalkyl, aryl, and substituted aryl. In some variations, each of R³ and R^{3′} is independently selected from C₁-C₆ alkyl and substituted C₁-C₆ alkyl. In some variations, each of R³ and R^{3′} is independently C₁-C₆ alkyl. In some variations, each of R³ and R^{3′} is methyl.

In some variations, each of X, Y, and Z is independently selected from hydrogen, alkyl, non-aryl substituted alkyl, heteroalkyl, non-aryl substituted heteroalkyl, or two of X, Y, and Z together with the carbon atom to which they are bonded form a cycloalkyl, non-aryl substituted cycloalkyl, cycloheteroalkyl, or non-aryl substituted cycloheteroalkyl ring. In some variations, each of X, Y, and Z is independently selected from C₁-C₂₀ alkyl, non-aryl substituted C₁-C₂₀ alkyl, C₁-C₂₀ heteroalkyl, and non-aryl substituted C₁-C₂₀ heteroalkyl, or two of X, Y, and Z together with the carbon atom to which they are bonded form a C₁-C₂₀ cycloalkyl, C₁-C₂₀ non-aryl substituted cycloalkyl, C₁-C₂₀ cycloheteroalkyl, or non-aryl substituted C₁-C₂₀ cycloheteroalkyl ring. In some variations, each of X, Y, and Z is independently selected from C₁-C₁₀ alkyl, non-aryl substituted C₁-C₁₀ alkyl, C₁-C₁₀ heteroalkyl, and non-aryl substituted C₁-C₁₀ heteroalkyl, or two of X, Y, and Z together with the carbon atom to which they are bonded form a C₁-C₁₀ cycloalkyl, C₁-C₁₀ non-aryl substituted cycloalkyl, C₁-C₁₀ cycloheteroalkyl, or non-aryl substituted C₁-C₁₀ cycloheteroalkyl ring.

In some variations, n is at least 5. In some variations, n is at least 50. In some variations n is at least 100. In some variations, n is at least 150. In some variations, n is at least 200. In some variations, n is at least 250. In some variations, n is equal to or less than 1000. In some variations, n is equal to or less than 800. In some variations, n is equal to or less than 600. In some variations, n is equal to or less than 500. In some variations, n is equal to or less than 400. In some variations, n is equal to or less than 300. In some variations, n is equal to or less than 250. In some variations, n is equal to or less than 200.

In some variations, p is an integer between 1 and 5. In some variations, p is an integer between 1 and 3. In some variations, p is 1.

In some variations, q is an integer between 1 and 5. In some variations, q is an integer between 1 and 3. In some variations, q is 1.

In some variations, s is an integer between 1 and 5. In some variations, s is an integer between 1 and 3. In some variations, s is 1.

In some variations, v is integer between 0 and 3. In some variations, v is integer between 1 and 6. In some variations, v is 0. In some variations, v is 1. In some variations, v is 2. In some variations, v is 3. In some variations, v is 4. In some variations, v is 5. In some variations, v is 6.

The variables in Formula (II) can be combined with other variable in Formula (II) in any combination. In some variations, the X-Y-Z substituent, the alicyclic side groups can be the same or different within a single SGM polymer. In other words, polymers can be made from different combinations of SGM monomers. In some variations, the X-Y-Z substituent can be a terpene radical.

In another variation, the disclosure is direct to a siloxane polymer according to the structural Formula (III):

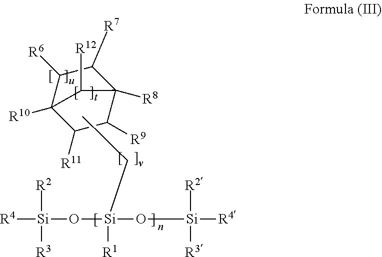

wherein

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, substituted heteroalkyl, aryl or substituted aryl;

each of R³ and R^{3′} is independently selected from hydrogen, alkyl, substituted alkyl, heteroalkyl, substituted heteroalkyl, aryl or substituted aryl;

each of R⁴ and R^{4′} is independently a reactive group;

each of R⁶, R⁷, R⁸, R⁹, R¹⁰, R¹¹, and R¹² is each independently selected from hydrogen, alkyl, non-aryl substituted alkyl, heteroalkyl, and non-aryl substituted heteroalkyl;

n is an integer between 5 and 10000;

u is an integer between 1 and 20;

t is an integer between 1 and 10; and

v is an integer between 0 and 6.

In some variations, R¹ is selected from alkyl and non-aryl substituted alkyl. In some variations, R¹ is selected from C₁-C₆ alkyl and C₁-C₆ non-aryl substituted alkyl. In some variations, R¹ is C₁-C₆ alkyl. In some variations, R¹ is methyl.

In some variations, each of R² and R^{2′} is independently selected from alkyl, substituted alkyl, heteroalkyl, and substituted heteroalkyl. In some variations, each of R² and R^{2′} is independently selected from C₁-C₆ alkyl, substituted C₁-C₆ alkyl, C₁-C₆ heteroalkyl, substituted C₁-C₆ heteroalkyl, aryl or substituted aryl. In some variations, each of R² and R^{2′} is independently selected from C₁-C₆ alkyl and substituted C₁-C₆ alkyl. In some variations, each of R² and R^{2′} is independently C₁-C₆ alkyl. In some variations, each of R² and R^{2′} is methyl.

In some variations, each of R³ and R^{3′} is independently selected from alkyl, substituted alkyl, heteroalkyl, and substituted heteroalkyl. In some variations, each of R³ and R^{3′} is independently selected from C₁-C₆ alkyl, substituted C₁-C₆ alkyl, C₁-C₆ heteroalkyl, substituted C₁-C₆ heteroalkyl, aryl or substituted aryl. In some variations, each of R³ and R^{3′} is independently selected from C₁-C₆ alkyl and substituted C₁-C₆ alkyl. In some variations, each of R³ and R^{3′} is independently C₁-C₆ alkyl. In some variations, each of R³ and R^{3′} is methyl. In some variations, each of R⁴ and R^{4′} is independently a reactive group. In some variations, each of R⁶, R⁷, R⁸, R⁹, R¹⁰, R¹¹ and R¹² is each independently selected from hydrogen, alkyl, heteroalkyl, and non-aryl substituted heteroalkyl.

In some variations, n is at least 5. In some variations, n is at least 50. In some variations n is at least 100. In some variations, n is at least 150. In some variations, n is at least 200. In some variations, n is at least 250. In some variations, n is equal to or less than 1000. In some variations, n is equal to or less than 800. In some variations, n is equal to or less than 600. In some variations, n is equal to or less than 500. In some variations, n is equal to or less than 400. In some variations, n is equal to or less than 300. In some variations, n is equal to or less than 250. In some variations, n is equal to or less than 200.

In some variations, u is an integer between 1 and 16. In some variations, u is an integer between 1 and 12. In some variations, u is an integer between 1 and 10. In some variations, u is an integer between 1 and 8. In some variations, u is an integer between 1 and 6. In some variations, u is an integer between 1 and 4. In some variations, u is an integer between 1 and 3. In some variations, u is an integer between 1 and 2. In some variations, u is 5. In some variations, u is 4. In some variations, u is 3. In some variations, u is 2. In some variations, u is 1.

In some variations, t is an integer between 1 and 8. In some variations, t is an integer between 1 and 6. In some variations, t is an integer between 1 and 4. In some variations, t is an integer between 1 and 3. In some variations, t is an integer between 1 and 2. In some variations, t is 8. In some variations, t is 7. In some variations, t is 6. In some variations, t is 5. In some variations, t is 4. In some variations, t is 3. In some variations, t is 2. In some variations, t is 1.

In some variations, v is integer between 0 and 3. In some variations, v is integer between 1 and 6. In some variations, v is 0. In some variations, v is 1. In some variations, v is 2. In some variations, v is 3. In some variations, v is 4. In some variations, v is 5. In some variations, v is 6.

The variables in Formula (III) can be combined with other variable in Formula (III) in any combination. In some variations, the SGM substituent, the alicyclic side groups can be the same or different within a single SGM polymer. In other words, polymers can be made from different combinations of SGM monomers.

In some variations, each of R⁶, R⁷, R⁸, R⁹, R¹⁰, R¹¹, and R¹² is each independently selected from hydrogen, C₁-C₂₀ alkyl and non-aryl substituted C₁-C₂₀ alkyl, C₁-C₂₀ heteroalkyl and non-aryl substituted C₁-C₂₀ heteroalkyl. In some variations, each of R⁶, R⁷, R⁸, R⁹, R¹⁰, R¹¹, and R¹² is each independently selected from hydrogen, C₁-C₁₆ alkyl and non-aryl substituted C₁-C₁₆ alkyl, C₁-C₁₆ heteroalkyl and non-aryl substituted C₁-C₁₆ heteroalkyl. In some variations, one of R⁶, R⁷, R⁸, R⁹, R¹⁰, R¹¹, and R¹² is non-hydrogen. In some variations, two of R⁶, R⁷, R⁸, R⁹, R¹⁰, R¹¹, and R¹² are non-hydrogen. In some variations, three of R⁶, R⁷, R⁸, R⁹, R¹⁰, R¹¹, and R¹² are non-hydrogen.

In another variation, the disclosure is direct to a siloxane polymer according to the structural Formula (IV):

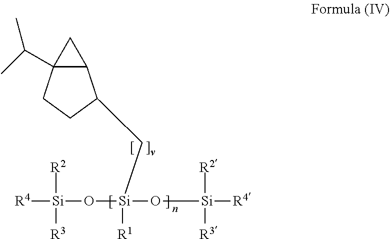

In another variation, the disclosure is direct to a siloxane polymer according to the structural Formula (V):

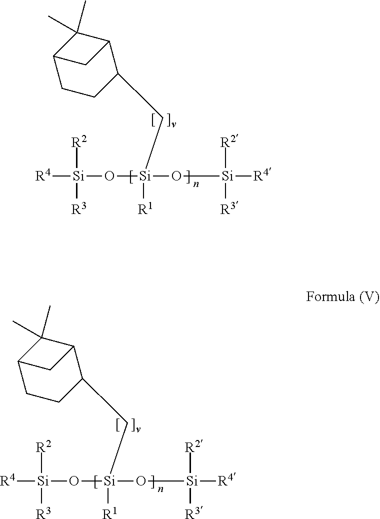

In another variation, the disclosure is direct to a siloxane polymer according to the structural Formula (VI):

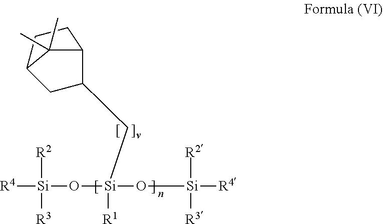

In another variation, the disclosure is direct to a siloxane polymer according to the structural Formula (VII):

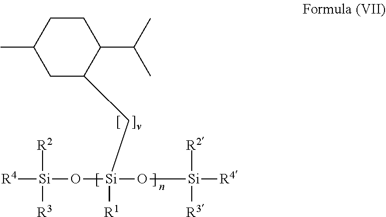

In another variation, the disclosure is direct to a siloxane polymer according to the structural Formula (VIII):

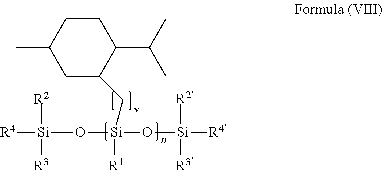

In another variation, the disclosure is direct to a siloxane polymer according to the structural Formula (IX):

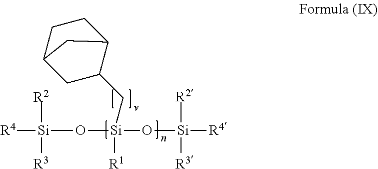

In another variation, the disclosure is direct to a siloxane polymer according to the structural Formula (X):

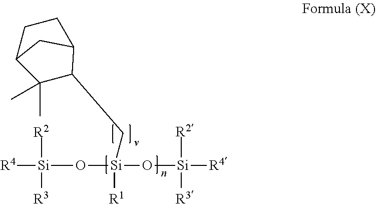

In another variation, the disclosure is direct to a siloxane polymer according to the structural Formula (XI):

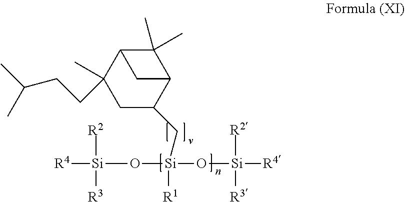

In another variation, the disclosure is direct to a siloxane polymer according to the structural Formula (XII):

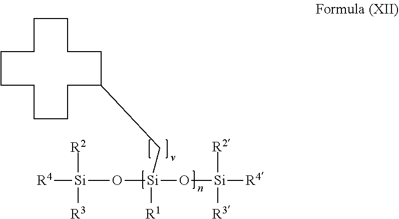

In another variation, the disclosure is direct to a siloxane polymer according to the structural Formula (XIII):

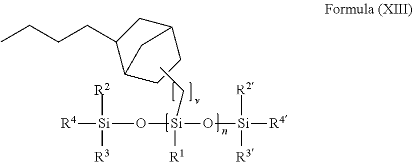

In another variation, the disclosure is direct to a siloxane polymer according to the structural Formula (XIV):

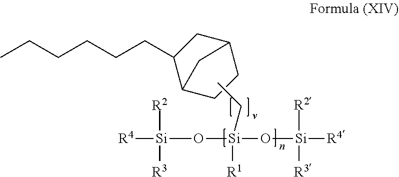

In another variation, the disclosure is direct to a siloxane polymer according to the structural Formula (XV):

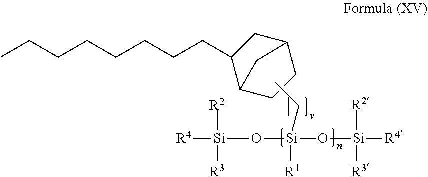

In another variation, the disclosure is direct to a siloxane polymer according to the structural Formula (XVI):

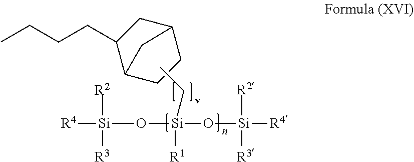

In another variation, the disclosure is direct to a siloxane polymer according to the structural Formula (XVII):

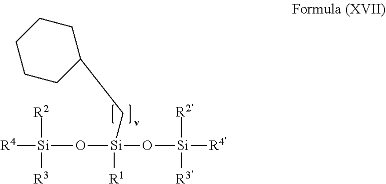

In another variation, the disclosure is direct to a siloxane polymer according to the structural Formula (XVIII):

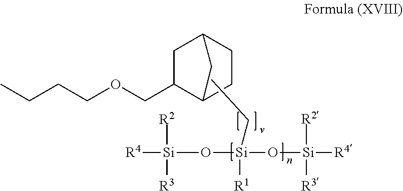

In another variation, the disclosure is direct to a siloxane polymer according to the structural Formula (XIX):

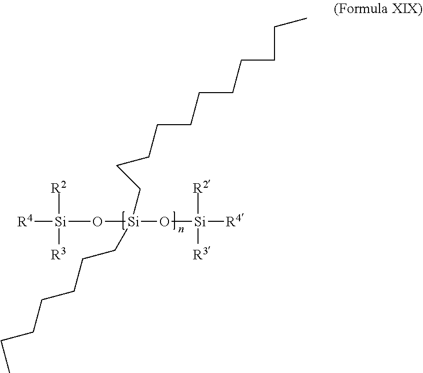

In each of Formulae (IV)-(XIX), and alternatively each of Formulae (IV)-(XVIII):

R¹ is selected from hydrogen, alkyl, non-aryl substituted alkyl, heteroalkyl, and non-aryl substituted heteroalkyl;

each of R² and R^{2′} is independently selected from hydrogen, alkyl, substituted alkyl, heteroalkyl, substituted heteroalkyl, aryl, or substituted aryl;

each of R³ and R^{3′} is independently selected from hydrogen, alkyl, substituted alkyl, heteroalkyl, and substituted heteroalkyl, aryl, or substituted aryl;

each of R⁴ and R^{4′} is individually a reactive group;

n is an integer between 5 and 10000; and

v is an integer between 0 and 6.

In some variations, R¹ is selected from alkyl and non-aryl substituted alkyl. In some variations, R¹ is selected from C₁-C₆ alkyl and C₁-C₆ non-aryl substituted alkyl. In some variations, R¹ is C₁-C₆ alkyl. In some variations, R¹ is methyl.

In some variations, each of R² and R^{2′} is independently selected from alkyl, substituted alkyl, heteroalkyl, substituted heteroalkyl, aryl or substituted aryl. In some variations, each of R² and R^{2′} is independently selected from C₁-C₆ alkyl, substituted C₁-C₆ alkyl, C₁-C₆ heteroalkyl, and substituted C₁-C₆ heteroalkyl. In some variations, each of R² and R^{2′} is independently selected from C₁-C₆ alkyl and substituted C₁-C₆ alkyl. In some variations, each of R² and R^{2′} is independently C₁-C₆ alkyl. In some variations, each of R² and R^{2′} is methyl.

In some variations, each of R³ and R^{3′} is independently selected from alkyl, substituted alkyl, heteroalkyl, substituted heteroalkyl, aryl or substituted aryl. In some variations, each of R³ and R^{3′} is independently selected from C₁-C₆ alkyl, substituted C₁-C₆ alkyl, C₁-C₆ heteroalkyl, and substituted C₁-C₆ heteroalkyl. In some variations, each of R³ and R^{3′} is independently selected from C₁-C₆ alkyl and substituted C₁-C₆ alkyl. In some variations, each of R³ and R^{3′} is independently C₁-C₆ alkyl. In some variations, each of R³ and R^{3′} is methyl.

In some variations, n is at least 5. In some variations, n is at least 50. In some variations n is at least 100. In some variations, n is at least 150. In some variations, n is at least 200. In some variations, n is at least 250. In some variations, n is equal to or less than 1000. In some variations, n is equal to or less than 800. In some variations, n is equal to or less than 600. In some variations, n is equal to or less than 500. In some variations, n is equal to or less than 400. In some variations, n is equal to or less than 300. In some variations, n is equal to or less than 250. In some variations, n is equal to or less than 200.

In some variations, v is integer between 0 and 3. In some variations, v is integer between 1 and 6. In some variations, v is 0. In some variations, v is 1. In some variations, v is 2. In some variations, v is 3. In some variations, v is 4. In some variations, v is 5. In some variations, v is 6.

The variables in Formulae (I)-(XIX) can be combined with other variable in any combination. In some variations, multiple SGM substituents can be in the same polymer. In other words, the alicyclic side groups can be the same or different within a single SGM polymer.

### Cured Silicone Rubbers

In some variations, the cured silicone rubbers as described herein can be a mixture or co-cure of poly-N1, N2-siloxane polymer and an SGM polysiloxane copolymer. In various embodiments, the cured silicone rubber has a maximum damping coefficient (tan δ) of the cured silicone rubber is in the frequency range below 20 kHz (e.g., 500 Hz-10 kHz) at ambient temperature.

In the poly-N1, N2-siloxane polymer, on each separate silicon atom, N1 and N2 are each independently selected from the group consisting of substituted or unsubstituted methyl, ethyl, propyl, butyl, pentyl, hexyl, heptyl, octyl, nonyl, tetradecyl, octadecyl, phenyl, phenylethyl, and 3,3,3-trifluoropropyl. The poly-N1, N2-siloxane polymer is also referred to herein as optionally substituted polydimethylsiloxane. The poly-N1, N2-siloxane polymer can be polydimethylsiloxane. In any variation disclosed herein, the substituents in the poly-N1, N2-siloxane polymer can be non-aryl substituents. It will be recognized that the cured silicone rubber as referred to herein can include some unreacted unsaturated moieties, e.g., vinyl moieties, remaining after curing.

In some variations, the cured silicone rubber has from 1 mol % to 99 mol % copolymer. In some variations, the cured silicone rubber has from 1 mol % to 70 mol % copolymer. In some variations, the cured silicone rubber has from 5 mol % to 50 mol % copolymer. In still other variations the cured silicone rubber has from 10 mol % to 30 mol % copolymer.

The cured silicone rubber can include additional components such as components from a polymerization reaction. In some variations, the cured silicone rubber can include a filler material such as carbon black, fumed silica, or titanium dioxide. In some variations, the cured silicone rubber can include typical additives such as dyes, softeners, oxidation inhibitors etc., known by the skilled in the art.

### Glass Transition Temperature

In some variations, cured silicone rubbers have a temperature maximum of tan δ at a given frequency. Because the maximum of tan δ is a result of a phase transition of second order, where the material changes its mechanical properties, such a phase transition (corresponding the glass transition temperature of the silicone rubber material) occurs at temperatures below the usual temperature of the use of the silicone rubber, such as when the silicone rubber is in a functioning electronic device. As such, the mechanical properties remain similar over the temperature interval, such as operation of an electronic devices.

Alternatively, higher glass temperatures may be useful for damping low frequency applications from 1-20 Hz (not in the audible frequency region) at ambient temperatures.

In some variations, the siloxane polymers have a structure of the compounds of Table 1. Table 1 provides the maximal damping temperature and measured peak maximum of tan δ at 1 kHz for a cured silicone rubbers that include a copolymer of 20% SGM siloxane polymers and 80% PDMS.

Those SGM materials showing a maximum temperature of tan δ of less than or equal to 0° C. (corresponding to the glass temperature of the rubber), and increase tan δ at 1 kHz can be suitable for use in an audio system. Those SGM materials showing a maximum temperature at higher temperatures (above 0° C., 10° C., or 20° C.) and increase tan δ are suitable for use in low frequency applications.

TABLE 1
Specific SGM Silicon Polymers and corresponding temperature at which damping is maximal, and
damping maximum.

| | | Temperature | |
|---|---|---|---|
| | | at which | |
| | | maximum | |
| | | in damping | Damping |
| | | is observed | Maximum |
| No. | Polymer | [° C.] | (tan δ) |
| 1 | 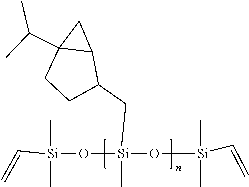 | −32 | 0.30 |
| 2 | 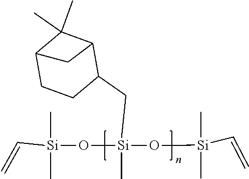 | 11 | 0.37 |
| 3 | 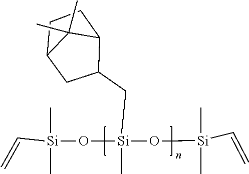 | 16 | 0.35 |
| 4 | 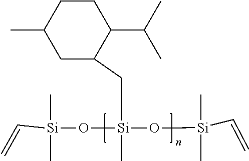 | 19 | 0.35 |
| 5 | 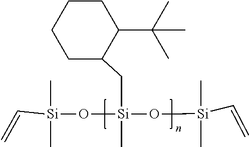 | 28 | 0.35 |
| 6 | 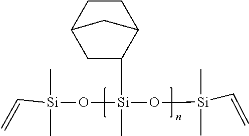 | 65 | 0.26 |
| 7 | 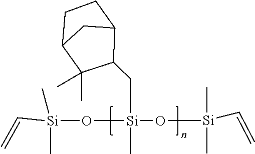 | 69 | 0.25 |
| 8 | 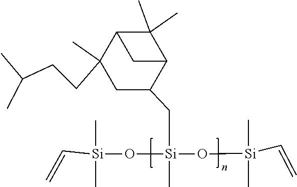 | 20 | 0.42 |
| 9 | 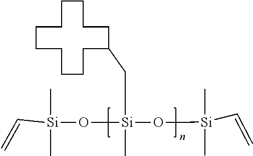 | 23 | 0.33 |
| 10 | 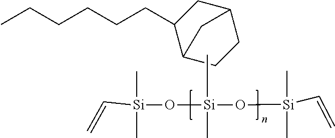 | −10 | 0.37 |
| 11 | 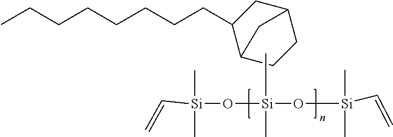 | −8 | 0.38 |
| 12 | 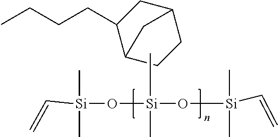 | 5 | 0.33 |
| 13 | 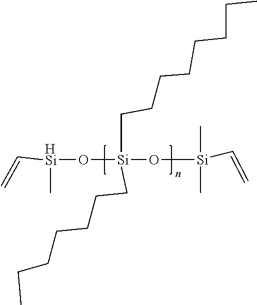 | 25 | 0.20 |
| 14 | 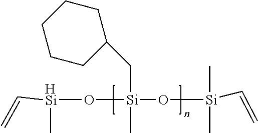 | −5 | 0.31 |
| 15 | 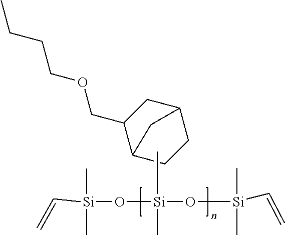 | −13 | 0.36 |

### Methods of Synthesis

The siloxane polymers can be synthesized by any method known in the art. For example, the siloxane polymers may be synthesized by attaching the side group to the siloxane backbone via hydrosilylation reaction. Different curing reactions are known, that can be triggered in a proper moment by light or heat. Curable silicone elastomer formulations are often platinum -cured silicone elastomers (which use for curing the addition reaction known in the art as “hydrosilylation”). However, platinum catalysts for the rubber curing process can be toxic and costly. The catalyst also can remain in the final cured silicone rubber. Platinum catalysis usually requires high temperature, whereas conventional light-curable (e.g., UV or visible light, such as 405 nm blue light) silicones need either increased temperature or prolonged cure time. In mass production, this results in lengthy production cycles, likelihood of errors, and requirement for expensive molding equipment. Thus, curing at ambient temperature has significant advantages.

In general, silicone rubber parts can be manufactured by pressing a polymer and copolymer formulation as described herein into a mold, followed by a curing process in which bonds between different polymers are formed on a molecular scale resulting in a cured silicone rubber.

In some variations, the disclosure is directed to a process for preparing cured silicone rubber articles and composite parts from a liquid silicone rubber formulation. Liquid curable silicone rubber formulations can cure or react to provide a cured silicone rubber, also known as a cured silicone elastomer (“elastomer” and “rubber” are used interchangeably herein).

Siloxane polymers that include SGM siloxane polymers, such as one or more compounds of Formulae (I)-(XIX), have reactive functionalities (e.g., vinyl groups), allowing for the formation of a three-dimensional polymeric network. The reactive functional groups can be R4 and R4′ in the compounds of Formulae (I)-(XIX). In some variations, the other radicals R1-R17 of Formulae (I)-(XIX) may also possess reactive groups suitable for a curing reaction.

The cured silicone rubbers described herein can be prepared by curing the optionally substituted polydimethylsiloxane bearing an unsaturated moiety and a SGM polysiloxane bearing an unsaturated moiety. In various aspects, the unsaturated moiety can be a vinyl substituent or a 2-(5-norborn-2-enyl)ethyl substituent. By bearing an unsaturated moiety, a polymer or copolymer can bear one more unsaturated moiety group, or one or more specific kind of unsaturated moiety, without limitation. Adding an unsaturated moiety, as described herein, can also be referred to as functionalizing a polymer or copolymer. A photoinitiator is added, optionally filler material, and optionally curing agent. Light radiation (e.g. UV or visible light, such as 405 nm blue light) is applied to cure the silicone rubber at ambient temperature. As used herein, ambient temperature is at least 20° C. and no greater than 30° C., alternatively at least 23° C. and no greater than 28° C., alternatively about 25° C.

In various aspects, UV or visible light such as, but not limited to, 405 nm blue light curing the to form the cured silicone rubber can proceed in one minute or less. In some variations, the curing can be accomplished in not more than 30 seconds. In some cases, curing can be accomplished in not more than 20 seconds. In further variations, curing can be accomplished in not more than 10 seconds.

In some variations, the curable silicone rubber formulations can include a poly-N1, N2-siloxane polymer, wherein, on each separate silicon atom, N1 and N2 are each independently selected from the group consisting of substituted or unsubstituted methyl, ethyl, propyl, butyl, pentyl, hexyl, heptyl, octyl, nonyl, tetradecyl, octadecyl, phenyl, phenylethyl, and 3,3,3-trifluoropropyl (e.g., polydimethylsiloxane (PDMS)). The poly-N1, N2-siloxane is a polymer of various molecular weights, bearing internal and/or terminal vinyl groups to allow for an addition reaction with a linker with the formation of 3-dimensional cured polymer. The cured silicone rubber can possess certain properties, such as elasticity and hardness.

### SGM Siloxane Polymer Synthesis

In some variations, the copolymer can be prepared by polymerizing SGM cyclosiloxanes, catalyzed by potassium hexamethydisilazide in the presence of tetraalkylureas as promotors, followed by the functionalization of the obtained copolymer. The copolymer can be dissolved in an ethereal solvent and precipitated with another solvent, such as alcohol.

In some variations, SGM polysiloxane copolymers can be synthesized by combining SGM precursors. They can be polymerized in the presence of potassium hexamethyldisilazide or other polymerization initiators and polymerization promotors at temperatures 20-170° C. Subsequently, the resulting product can be dissolved in an ethereal solvent, and a silylation agent can be added. The resulting product can be alcohol-precipitated, for example by using an aliphatic alcohol as a precipitating solvent.

In some variations, the promotor is a substituted tetraalkylurea (e.g., such as 1,3-dimethylimidazolidinone).

In some variations, the ethereal solvent is selected from tetrahydrofuran, 2-methyltetrahydrofuran, cyclopentyl methyl ether, diethoxymethane, dipropoxymethane, tert-amyl methyl ether, tert-butyl ethyl ether. In some embodiments, the ethereal solvent is tetrahydrofuran.

In some variations, the silylation agent is a substituted chlorodialkylsilane, chlorodiarylsilane, or aminodialkylsilane. In a some embodiments, the silylating agent is vinyldimethylchlorosilane. Non-limiting examples of bases can include triethylamine, pyridine, diisopropylethylamine and other substances known in the art.

### Formulations

A formulation of SGM siloxanes, crosslinker, a filler, and an initiator or catalyst, can be prepared. SGM siloxanes can exhibit high viscosity, which can impede many molding processes. An SGM polysiloxane can include a poly-N1, N2-siloxane polymer such as poly(dimethyl)siloxane. Additional fillers or other additives can be added to further adjust the mechanical properties of the product. In some variations, the additives can be known in the art.

Curable silicone elastomer compositions can be platinum -cured silicone elastomers (the used addition reaction for curing is known as hydrosilylation in the art). In this case, Si—H compounds are added to the curable mixture as cross-linkers.

In some variations, the formulation can include other materials. For example, the formulation can optionally include curing agents, fillers, viscosity regulators, chain extenders, catalysators, dyes, and other additives known in the art.

The formulation can include a catalyst. In some variations, the catalyst is a radical initiator for a thiol-ene cure reaction or a platinum compound for hydrosilylation cure reaction. In particular variations, the catalyst is a radical initiator for a thiol-ene cure reaction.

The formulation can include a filler material, for example, a filler material is selected from carbon black, fumed silica, and titanium dioxide. In particular variations, the filler material is fumed silica.

A curing agent containing thiol moieties can be added to the formulation. In some variations, the curing agent has between 2 and 100 mercapto groups in the molecule. In more specific variations, the curing agent is an alkylsiloxane, containing between 3 and 10 mercapto groups in the molecule. In a more specific variation, the curing agent is 1,3,5,7-tetramethyl-1,3,5,7-tetra(3-mercaptopropyl)cyclotetrasiloxane or 1,3,5-trimethyl-1,3,5-tri(3-mercaptopropyl)cyclotrisiloxane. In some variations, the curing agent is mercaptopropyl-siloxane oligomer (e.g., SMS-992 from Gelest).

In some variations, the cured silicone rubber is cured at ambient temperature. In some variations, the formulation can include a curing agent such as a thiol-containing curing agent. The curing process can include a radical thiol-alkene addition reaction with alkenyl groups when present.

The silicone rubber can also include a methylhydrosiloxane copolymer as a cross-linker and a platinum catalyst. This process is well -known in the art. Platinum catalyst can be activated either by temperature (thus, the composition may contain a suitable inhibitor of platinum cure to ensure a sufficient pot life) or by light. So, the cure process can be performed using either by thermally or light-promoted platinum catalysis.

The mixture of poly-N1, N2-siloxane polymer with a SGM polymer may be either homogeneous, or heterogeneous. In heterogenous mixtures, the SGM polymer can form a second phase, distributed in the matrix of poly-N1, N2-siloxane. Alternatively, the poly-N1, N2-siloxane can form a second phase distributed in the matrix of the SGM polymer. The second phase can form a 3-dimensional polymer network, or remain in non-polymerized oligomeric form. In some cases, a SGM polymer, forming such a second phase distributed over the matrix of poly-N1, N2-siloxane, can be extracted from the final rubber and analyzed by the methods known in the art.

In some variations, the ratio of SGM polysiloxane copolymer and poly-N1, N2-siloxane polymer (e.g., PDMS) is no greater than 3:1. In some variations, the ratio is no greater than 2:1. In some variations, the ratio is no greater than 1:1. In some variations, the ratio is no greater than 1:2. In some variations, the ratio is no greater than 1:5. In some variations, the ratio is no greater than 1:10. In some variations, the ratio is no greater than 1:15. In some variations, the ratio is no less than 1:20. In some variations, the ratio is no less than 1:15. In some variations, the ratio is no less than 1:10. In some variations, the ratio is no less than 1:5. In some variations, the ratio is no less than 1:20. In some variations, the ratio is no less than 1:2. In some variations, the ratio is no less than 1:1. In some variations, the ratio is no less than 2:1. In some variations, the ratio is between 2:1 to 1:20. In a variation, the proportion is between 1:10 and 1:2.

### Apparatuses

In some variations, vibrational feedback of particular low frequencies should not be damped by the device. For example, in handheld devices vibrational feedback of low frequencies is not damped, while high frequency disharmonic overtones emitted by loudspeakers can be damped.

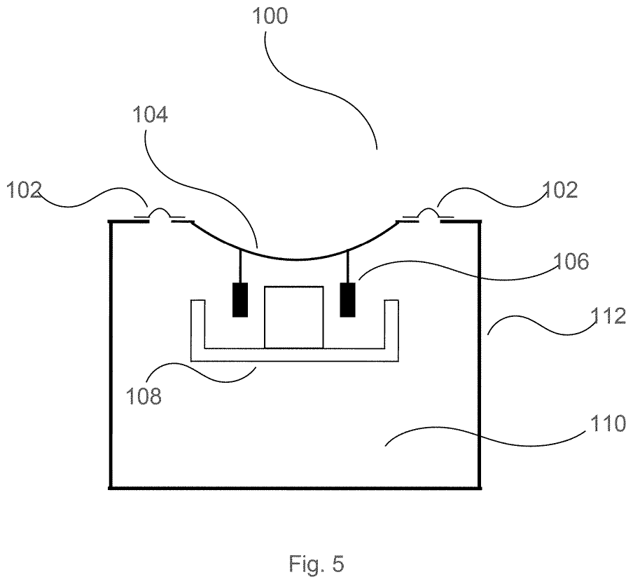

FIG. 5 illustrates a speaker 100, in accordance with various aspects of the subject technology. The speaker 100 can be used in any type of handheld electronic device. Speaker 100 includes cured silicone rubber membrane 102 made of cured rubber silicone. Rubber membrane 102 holds diaphragm 104. Magnetic assembly 108 is located in cavity 110 enclosed by housing 112. An electric current running through coils 106 (e.g., copper coils) generates a magnetic field that interacts with and magnetic assembly. Diaphragm 104 oscillates in magnetic assembly 108 to create sound.

Cured silicone rubber membrane 102 can damps sound at a particular frequency or range of frequencies. Speaker 100 can show unfavorable oscillation modes of diaphragm 104, leading to a distorted acoustic output. A reduction of the amplitudes of these modes by damping improves therefore the quality of the sound.

### EXAMPLES

The following non-limiting examples are included to demonstrate certain embodiments of the present disclosure. It should be appreciated by those of skill in the art that the techniques disclosed in the examples which follow represent techniques discovered by the inventors to function well in the practice of the subject matter of the present. However, those of skill in the art should, in light of the present disclosure, appreciate that many changes can be made to the specific embodiments disclosed herein and still obtain a like or similar result without departing from the spirit and scope of the subject matter of the present disclosure.

### Example 1

### Preparation of Silicone Rubber Containing Sabinyl Side Groups methyl(4-(1-isopropylbicyclo[3.1.0]hexyl))methyldichlorosilane

Into a 250 mL flask was placed 50 mL toluene, 0.3 mL diisopropylethylamine, 33 mL of methyldichlorosilane and 0.5 mL of Karstedt catalyst solution in siloxanes (0.5% platinum). Into the flask, 38 mL of alpha-sabinene was slowly added under temperature control (below 60° C.). After the addition, the flask was heated at 60° C. overnight. The products were concentrated and distilled, collecting fraction with b. p. 63-64° C. at 0.25 mbar.

### Mixture of Cyclic Oligomeric Siloxanes Containing methyl(4-(1-isopropylbicyclo[3.1.0]hexyl)) Groups

Into a flask was placed 15 g of sodium hydrocarbonate, 13 mL pyridine and 200 mL acetone. With stirring, 36 g of methyl(4-(1-isopropylbicyclo[3.1.0]hexyl))-methyldichlorosilane, prepared as above, was added dropwise. The mixture was stirred overnight. Solids were filtered off, the residue was concentrated and heated in vacuum at 140° C. for 1 h to remove volatiles. By analytical data, the product consists of cyclotri- and cyclotetrasiloxanes, bearing a methyl(4-(1-isopropylbicyclo[3.1.0]hexyl)) and a methyl group on each silica atom.

### Vinyl-Terminated Siloxane Polymer Containing methyl(4-(1-isopropylbicyclo[3.1.0]hexyl)) Groups

10 g of cyclic oligomeric siloxanes mixture with methyl(4-(1-isopropylbicyclo[3.1.0]hexyl)) side chains, prepared as above, was placed into a 50 mL flask with septum and heated to 100° C. in vacuum. By a syringe, 0.5 mL of 30% solution of potassium hexamethyldisilazide in 1,3-dimethylimidazolidinone (DMI) was added, and the mixture was stirred at 150° C. for 30 min. On cooling, the product was diluted with 40 mL of THF, and 0.5 mL triethylamine followed by 0.25 mL of vinyldimethylchlorosilane was added.

After 1 h, 30 mL of methanol was added. The polymer was collected by centrifugation and dried in vacuum at 80° C.

### Silicone Rubber Containing methyl(4-(1-isopropylbicyclo[3.1.0]hexyl)) Side Groups

Into a 30-mL SpeedMixer vial, was placed 1.0 g of the siloxane polymer containing methyl(4-(1-isopropylbicyclo[3.1.0]hexyl)) groups prepared as above, 1.1 g of VS65000 vinyl-terminated polydimethylsiloxane (Evonik), 1.7 g of VQM907 silicone polymer (Evonik), 1.2 g of Aerosil R8200 (Evonik), and 100 mg of SMS-992 ((3-mercaptopropyl)methylsiloxane polymer from Gelest). The components were mixed for several minutes, and 5 mg of TPO radical initiator as solution in THF was added. The components mixed again in vacuum for several minutes. The obtained mass was cured by UV light at room temperature using Anton Paar rheometer equipped with a DELO UV lamp. The silicone rubber obtained has tan δ max of 0.4 at −32° C., and suitable mechanical properties for use in acoustic devices.

### Example 2

### Preparation of Silicone Rubber Containing methyl-6-(4-methyl-4-isoamylbicyclo[3.3.1]heptyl) Side Groups

### 6-oxo-4-methyl-4-isoamylbicyclo[3.3.1]heptane

### Preparation of the 1,4-Addition Catalyst Solution

Into a 0.5 L round-bottom flask was placed 34 g of MnCl₂, 2.7 g of CuCN, and 35 g of LiCl. The flask was placed into an oven, the contents were dried at 200° C. for 2 h and cooled under argon. THF (250 mL) was added to the flask, the mixture was stirred overnight and the solids were let to settle down. The clear solution was decanted from the precipitate and stored in a Schlenk flask under argon.

### Synthesis of 6-oxo-4-methyl-4-isoamylbicyclo[3.3.1]heptane

Into a 3-necked 1 L round-bottom flask with a mechanical stirrer, thermometer, septum and argon inlet was placed 80 mL of 1,4-addition catalyst THF solution, prepared as above, and 45 mL of verbenone. Air was changed for argon, the mixture cooled to −10° C., and 200 mL of 1.5 M isoamylmagnesium bromide in THF was added slowly, keeping temperature between −5 and 5° C. After 2 h, the flask contents were poured into a mixture of 300 mL of saturated NH₄Cl and 50 mL conc. HCl. Organic phase was washed with saturated brine, dried and concentrated. 6-oxo-4-methyl-4-isoamylbicyclo[3.3.1]heptane was obtained in quantitative yield.

### 6-methylene-4-methyl-4-isoamylbicyclo[3.3.1]heptane

Into a 1 L 3-necked round-bottom flask with a thermometer, mechanical stirrer and distillation line was placed 250 mL of diisopropyl ether, 111 g of methyltriphenylphosphonium bromide and 35 g of potassium tert-butylate. The solvent was distilled off with stirring, until temperature in the flask reached 90° C. The reaction mass turned into viscous orange oil. With a good stirring, 63 g of 6-oxo-4-methyl-4-isoamylbicyclo[3.3.1]heptane was added dropwise, keeping temperature below 100° C. The mixture was stirred at 90° C. for 1 h and cooled, 200 mL pentane and 20 mL water were added, stirred for 30 min, filtered, the solids washed with pentane. The filtrate was passed through a pad of silica, concentrated in vacuum, and the product was purified by distillation, collecting fraction 65-70° C./1 mbar.

### (6-(4-methyl-4-isoamylbicyclo[3.3.1]heptylmethyl)methyldichlorosilane

6-methylene-4-methyl-4-isoamylbicyclo[3.3.1]heptane (50 g), prepared as above, 3 g of Karstedt catalyst solution (0.5% mass. Pt), 30 mL toluene and 35 g of methyldichlorosilane were placed into a 200 mL Teflon-lined steel autoclave, and heated at 125° C. for 8 h. Volatiles were removed in vacuum, and the residue was distilled, collecting fraction 75-80° C./0.25 mbar.

### Mixture of Cyclic Oligomeric Siloxanes Containing methyl-6-(4-methyl-4-isoamylbicyclo[3.3.1]heptyl) Groups

Into a 0.5 L round-bottom flask was placed 12 g of sodium hydrocarbonate, 12 mL pyridine and 200 mL acetone. With stirring, 41 g of (6-(4-methyl-4-isoamylbicyclo[3.3.1]heptylmethyl)methyldichlorosilane, prepared as above, was added dropwise. The mixture was stirred overnight. Solids were filtered off, the residue was concentrated and heated in vacuum at 140° C. for 1 h to remove volatiles. By analytical data, the product consist of cyclotri- and cyclotetrasiloxanes, bearing a methyl-6(4-methyl-4-isoamylbicyclo[3.3.1]heptyl) group on each silica atom.

### Vinyl-Terminated Siloxane Polymer Containing methyl-6-(4-methyl-4-isoamylbicyclo[3.3.1]heptyl) Groups

10 g of cyclic oligomeric siloxanes mixture with methyl-6-(4-methyl-4-isoamylbicyclo[3.3.1]heptyl) side chains, prepared as above, was placed into a 50 mL flask with septum and heated to 100° C. in vacuum. By a syringe, 0.5 mL of 30% solution of potassium hexamethyldisilazide in DMI was added, and the mixture was stirred at 150° C. for 30 min. On cooling down, the product was diluted with 40 mL of THF, and 0.5 mL triethylamine followed by 0.25 mL of vinyldimethylchlorosilane was added. After 1 h, 30 mL of methanol was added. The polymer was collected by centrifugation and dried in vacuum at 80° C.

### Silicone Rubber Containing methyl-6-(4-methyl-4-isoamylbicyclo[3.3.1]heptyl) Side Groups

Into a 30-mL SpeedMixer vial, was placed 1.0 g of the siloxane polymer containing methyl-6-(4-methyl-4-isoamylbicyclo[3.3.1]heptyl) groups prepared as above, 1.1 g of VS65000 vinyl-terminated polydimethylsiloxane (Evonik), 1.7 g of VQM907 silicone polymer (Evonik), 1.2 g of Aerosil R8200 (Evonik), and 75 mg of SMS-992 ((3-mercaptopropyl)methylsiloxane polymer from Gelest). The components were mixed for several minutes, and 5 mg of TPO radical initiator (solution in THF) was added. The component mixed again in vacuum for several minutes. The obtained mass was cured at room temperature using Anton Paar rheometer equipped with a DELO UV lamp. The silicone rubber obtained has tan δ max of 0.32 at 20° C., and suitable mechanical properties for use in acoustic devices.

### Example 3

### Preparation of Silicone Rubber Containing 2-(5(6)-n-octyl)norbornyl Side Groups

### 5-Octylnorbornene

Into a Teflon-lined steel autoclave, 400 mL of decene-1, 130 g of cyclopentadiene dimer, and 2 g of 2,6-dimethyl-4-tert-butylphenol were placed. The autoclave was heated at 205° C. for 8 h and left to cool overnight. The mixture was distilled, the product collected at 64-65° C./1 mbar.

### Methyl(5(6)-n-octylnorborn-2-yl)dichlorosilane (Mixture of 5- and 6-isomers)

In a 0.5 L 2-necked flask with thermometer and a dropping funnel, to 150 g of 5-n-octylnorbornene was added Karstedt catalyst to achieve 100 ppm of platinum content in the final mixture. The mixture was heated to 75° C., and dichloromethylsilane was added dropwise with intermittent cooling, keeping temperature at 85-90° C. After the addition, the mixture was heated at 75° C. for 2 h and then distilled in vacuum, collecting fraction 114-116° C./0.25 mbar.

### Mixture of Cyclic Oligomeric Siloxanes Containing 2-(5(6)-n-octyl)norbornyl Groups

To 300 mL of MIBK were added 50 g sodium hydrocarbonate, 25 mL pyridine and 90 g of methyl(5(6)-octylnorborn-2-yl)dichlorosilane. The mixture was stirred overnight, filtered and concentrated in vacuum, then heated at 145° C. and 1 mbar for 1 h to remove volatiles.

### Vinyl-Terminated Siloxane Polymer Containing 2-(5(6)-n-octyl)norbornyl Groups

10 g of cyclic oligomeric siloxanes mixture with 2-(5(6)-n-octyl)norbornyl side chains, prepared as above, was placed into a 50 mL flask with septum and heated to 100° C. in vacuum. By a syringe, 0.5 mL of 30% solution of potassium hexamethyldisilazide in DMI was added, and the mixture was stirred at 150° C. for 30 min. On cooling down, the product was diluted with 40 mL of THF, and 0.5 mL triethylamine followed by 0.25 mL of vinyldimethylchlorosilane was added. After 1 h, 30 mL of methanol was added. The polymer was collected by centrifugation and dried in vacuum at 80° C.

### Silicone Rubber Containing 2-(5(6)-n-octyl)norbornyl Side Groups

Into a 30-mL SpeedMixer vial, was placed 1.0 g of the siloxane polymer containing 2-(5(6)-n-octyl)norbornyl side groups prepared as above, 1.1 g of VS65000 vinyl-terminated polydimethylsiloxane (Evonik), 1.7 g of VQM907 silicone polymer (Evonik), 1.2 g of Aerosil R8200 (Evonik), and 75 mg of SMS-992 (3-mercaptopropyl)methylsiloxane polymer from Gelest. The components mixed for several minutes, and 5 mg of TPO radical initiator (solution in THF) was added. The component mixed again in vacuum for several minutes. The obtained mass was cured at room temperature using Anton Paar rheometer equipped with a DELO UV lamp. The silicone rubber obtained has tan δ max of 0.37 at −8° C., and suitable mechanical properties for use in acoustic devices.

### Example 4

### Preparation of Silicone Rubber Containing 2-(5(6)-n-octyl)norbornyl and cyclohexyl Side Groups

### Mixture of Cyclic Oligomeric Siloxanes Containing 2-(5(6)-n-octyl)norbornyl and cyclohexyl Groups

To 300 mL of MIBK were added 50 g sodium hydrocarbonate, 25 mL pyridine, 45 g of methyl(5(6)-octylnorborn-2-yl)dichlorosilane and 45 g of commercial cyclohexylmethyl-dichlorosilane (Gelest). The mixture was stirred overnight, filtered and concentrated in vacuum, finally heated at 145° C. and 1 mbar for 1 h.

### Vinyl-Terminated Siloxane Polymer Containing 2-(5(6)-n-octyl)norbornyl and cyclohexyl Groups

10 g of cyclic oligomeric siloxanes mixture with 2-(5(6)-n-octyl)norbornyl and cyclohexyl side chains, prepared as above, was placed into a 50 mL flask with septum and heated to 100° C. in vacuum. By a syringe, 0.5 mL of 30% solution of potassium hexamethyldisilazide in DMI was added, and the mixture was stirred at 150° C. for 30 min. On cooling down, the product was diluted with 40 mL of THF, and 0.5 mL triethylamine followed by 0.25 mL of vinyldimethylchlorosilane was added. After 1 h, 30 mL of methanol was added. The polymer was collected by centrifugation and dried in vacuum at 80° C.

### Silicone Rubber Containing 2-(5(6)-n-octyl)norbornyl and cyclohexyl Side Groups

Into a 30-mL SpeedMixer vial, was placed 1.0 g of the siloxane polymer containing 5/6-n-octylnorbornyl and cyclohexyl side groups prepared as above, 1.1 g of VS65000 vinyl-terminated polydimethylsiloxane (Evonik), 1.7 g of VQM907 silicone polymer (Evonik), 1.2 g of Aerosil R8200 (Evonik), and 75 mg of SMS-992 (3-mercaptopropyl)methylsiloxane polymer from Gelest. The components mixed for several minutes, and 5 mg of TPO radical initiator (solution in THF) was added. The component mixed again in vacuum for several minutes. The obtained mass was cured at room temperature using Anton Paar rheometer equipped with a DELO UV lamp. The silicone rubber obtained has tan δ max of 0.45, and suitable mechanical properties for use in acoustic devices.

### Example 5

### Extraction of the Silicone Rubber Containing SGM Siloxane with 2-(5(6)-n-octyl)norbornyl Side Groups and Recording an IR Spectrum

A sample of silicone rubber (ca. 0.2 g), prepared as described in Example 3, was placed into a 100 mL flask, containing 50 mL of cyclohexane. The silicone rubber was taken of the extraction solution and dried after every 24 hours. If mass differed from the previous measurement, the extraction was continued. After 72 hours the mass did not change anymore, so the extraction process was terminated.

The cyclohexane extract was concentrated to dryness, and the residue was analyzed by gel-permeation chromatography and IR spectroscopy. FIG. 6 depicts the resulting IR spectrum. It was obtained with a Bruker Alpha II FT-IR spectrometer.

### Example 6

Cross sectional cuts of cured silicone formulations were gathered by carefully slicing silicone rubbers with a scalpel and recording scanning electron microscopic images. A Phenom Pro X electron microscope with an acceleration voltage of 5 kV was used. Samples were not sputtered.

SEM pictures revealed the heterogeneous distribution of SGM siloxanes. The used SEM depicts areas of lower electron density in a darker mode. Since the electron density of polydimethylsiloxane is much higher than of any of the SGM siloxanes, roundish and dark areas in cross sectional cuts were attributed to the SGM siloxanes.

SMG siloxanes comprise a lower electron density, since the amount of Silicone atoms per volume is diminished in comparison to polydimethylsiloxane. A Silicone atom with an atomic number of 28 contains 28 electrons, whereas carbon only contains 6 electrons.

The mostly roundish shape of the SGM siloxane containing areas is likely a result of the tendency to lower the contact area between SMG and surrounding matrix due to the different surface energy of both phases.

The effect of this inhomogenities on the materials properties, especially the damping properties, is unclear to us.

### Example 7

Rheometer and DMA Measurements are described.

Viscosity curves of uncured rubber and UV-curing curves were recorded on a Anton Paar MCR 702 rheometer equipped with a Delolux 80/365 UV-light source on the lower side.

Measurements were performed in plate-plate configuration with a shear deformation controlled oscillatory test at a frequency of 10 Hz. Shear deformation was set to 0.1% for all measurements. Upper plate was a PP25 with a diameter of 25 mm, lower plate was a UV-transparent glass plate from Anton Paar. Delolux 80/365 was providing UV light for curing with a nominal wavelength of 365 nm and an intensity of 950 mW/cm² measured at the surface of the transparent glass plate on the lower side of the rheometer. The UV intensity was periodically monitored with a DeloluxControll measuring head with a diameter of 9 mm.

Viscosity curves of uncured rubber were recorded at a constant temperature of 25° C., a frequency of 10 Hz and a shear deformation of 0.1%. UV-curing curves were recorded at a constant temperature of 25° C., a frequency of 10 Hz and a shear deformation of 0.1%. UV curing was done for 30 s at an intensity of 950 mW/cm2.

Cured specimen were removed from the rheometer and further cut into shape for DMA testing. Specimen were cut for DMA testing by hand using guillotine shears, metal ruler and scalpel blades to fit DMA sample holder.

DMA curves were recorded on a Mettler Toledo DMA/SDTA 1+. All DMA measurements were performed in tensile mode using a deformation-controlled sinusoidal signal at 1% deformation. The clamped specimen length was predetermined by the specimen holder and fixed at 9 mm. Initial specimen were of 20 mm to 25 mm length, 3 mm to 5 mm width and 0.5 mm to 1 mm thickness.

Specimen were clamped in the specimen holder using textured brackets to prevent from slipping. Excessive material of the specimen was removed with scalpel blades to prevent from unintentional contact with the specimen holder. The specimen holder with the mounted specimen in place was then fixed in the DMA for testing.

DMA temperature sweeps were recorded in a temperature range of −110° C. to +100° C. Temperature sweeps were using a deformation-controlled sinusoidal signal at 1% deformation, a frequency of 1 Hz and a temperature ramp of 2K/min.

To create master curves, isothermal frequency sweeps were performed using a deformation-controlled sinusoidal signal at 1% deformation. Isothermal frequency sweeps were recorded in a range of 0.1 Hz to 100 Hz. At least 20 isothermal segments were recorded in a temperature range of −38° C. to +40° C. Isothermal frequency sweeps were fitted according to WLF theory to create master curves.

### Example 8

To compare the properties of the siloxane polymers bearing different side groupside groups and test them for constant mechanical properties over a wide temperature interval, the E-modulus as well as the damping properties, e.g. the tan δ, were recorded as function of temperature.

The cured silicone rubbers contained 20% of the SGM siloxanes.

In some variations, cycloalkyl groups with bridging groups can have a long chain substituent results in a lower glass transition temperature. For example, in the compounds of Formula (III), substituents from a cycloalkyl group with a bridged structure and one or more substituents results in a lower temperature at which maximum damping is observed (compounds 10, 11, and 12).

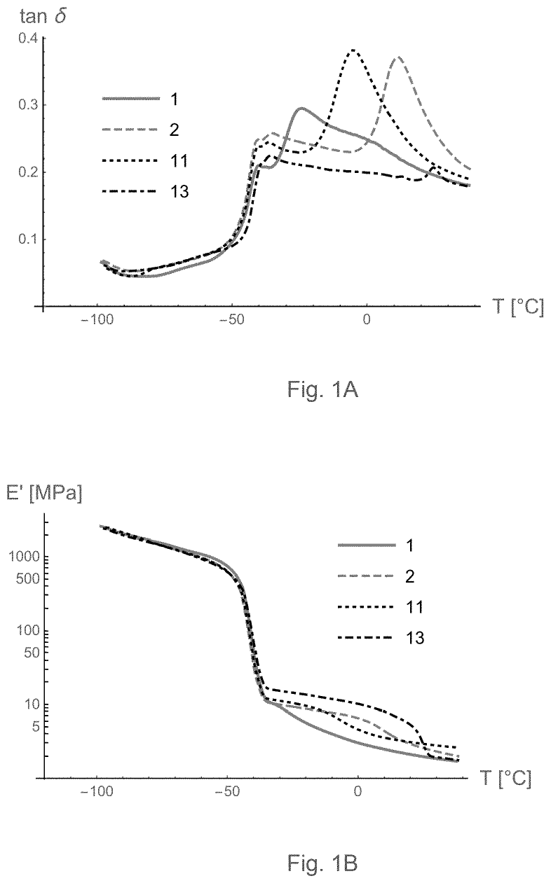

With respect to FIG. 1A, Compound 13 corresponding to a non-alicyclic side group shows no peak tan δ. In FIG. 1B, Compound 13 shows a steep drop of E′ at 30° C., corresponding to a physical change at the glass transition temperature (also in reference to Table 1, in which the temperature of maximal damping occurs at 25° C.). By contrast, compound 11 shows a peak tan δ of 0.4 and has a maximum damping temperature of −8° C. While compound 2 also has a tan δ peak approaching 0.4, it has a temperature at which maximum damping is 11° C. As such, the compound is not suitable for selection in a loudspeaker.

The alicyclic side groups listed in Table 1 under compounds 10 and 11, namely, 2-(5(6)-n-hexyl)norbornyl- and 2-(5(6)-n-octyl)norbornyl, provide materials with glass transition temperatures of about −10° C. and −8° C. respectively. Most electronic devices are operated at much higher temperature, so especially these side groups provide advantageous properties.

It can be seen on FIG. 1 that the E-modulus of the material does not change significantly above 0° C. In FIG. 1, curve 10 refers to entry 10, and curve 11 revers to entry 11 in Table 1.

The glass transition temperatures were defined by determining the damping maximum.

Another side group leading to a phase transition at temperatures below 0° C. was the methyl-6(4-methyl-4-isoamylbicyclo[3.3.1]heptyl) group, listed as first entry in Table 1. However, due to the presence of a 3-membered ring in this group, the material containing it is not sufficiently stable over the temperature range to which the final electronic device can be exposed. For this reason, the methyl-6(4-methyl-4-isoamylbicyclo[3.3.1]heptyl) side group was not considered for further investigations. It is well known to the expert in the art, that three membered rings are not very stable in harsh environments due to the large ring tension.

Unexpectedly, the obtained data showed that a long chain, non-cyclic alkane (entry no. 13 in Table 1) improve damping properties quite poorly in comparison with the cyclic side groups, as can be clearly seen in FIGS. 1A and 1B, as described herein.

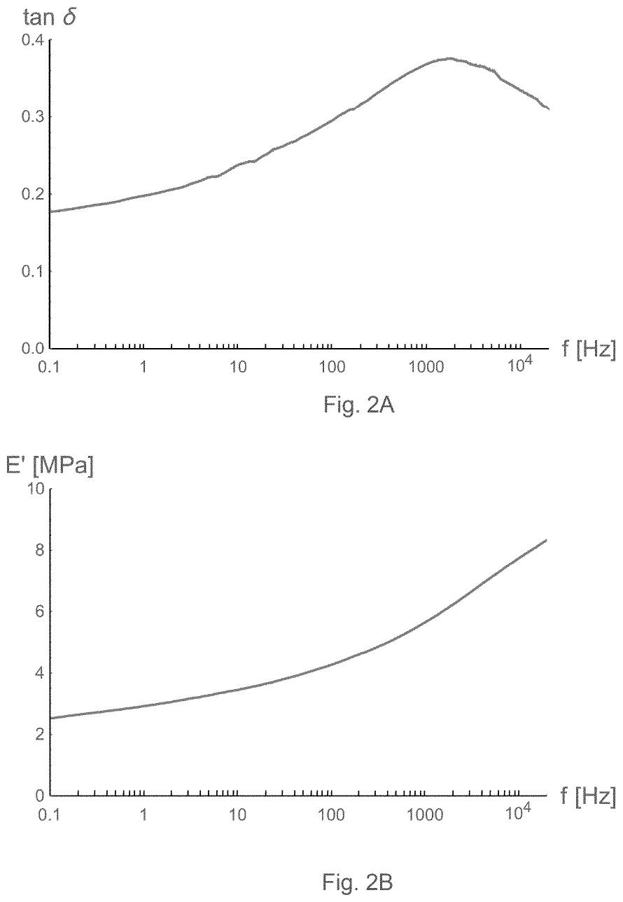

Since for the use as surround in loudspeakers the silicone rubber should provide good damping properties in the acoustic frequency range, e.g. between 1 and 20000 Hz, the E-Modulus and the tan δ were determined and are shown in FIG. 2A. For some materials containing siloxanes with alicyclic side groups, the damping maximum is advantageously at about 2000 Hz, clearly within the acoustic frequency range, reaching a value of 0.4 or more. In FIG. 2B, the E modulus increases slowly as a function of frequency.

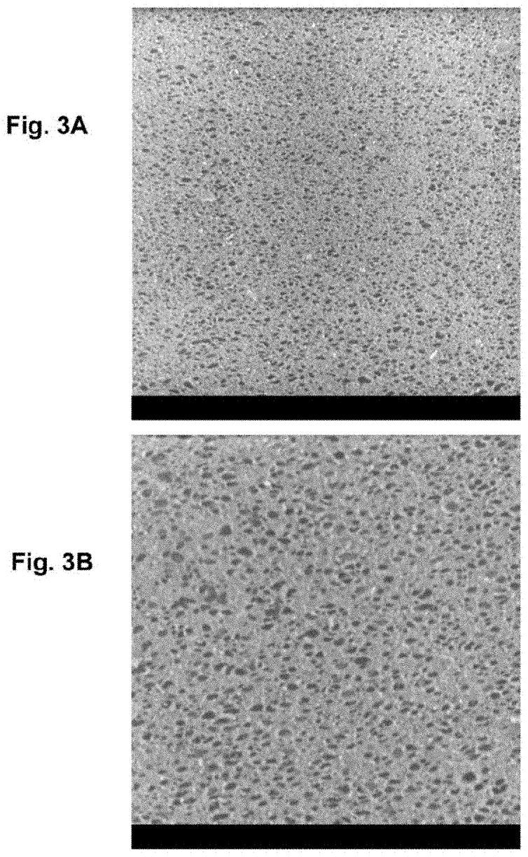

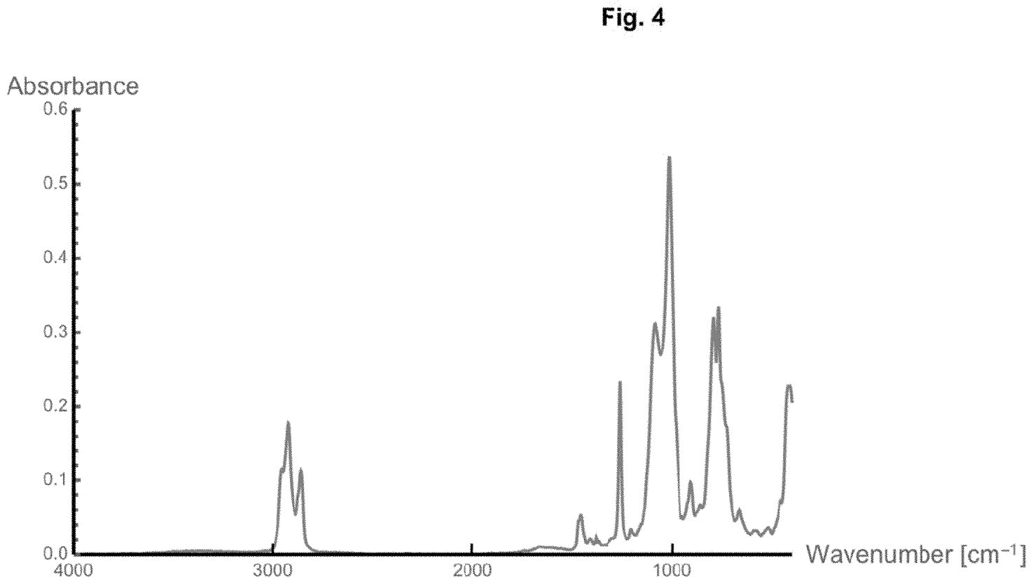

In FIGS. 3A and 3B at two different magnifications, the cured rubber is inhomogeneous, having at least two phases. The regions of lower electron density are darker, corresponding to the SGM siloxane.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A compound having the structure of Formula (I): 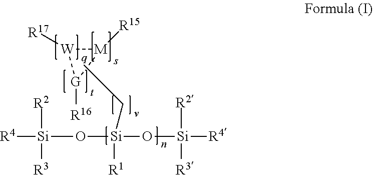
wherein
R¹ is selected from hydrogen, alkyl, non-aryl substituted alkyl, heteroalkyl, and non-aryl substituted heteroalkyl;
each of R² and R^{2′} is independently selected from hydrogen, alkyl, substituted alkyl, heteroalkyl, substituted heteroalkyl, aryl, and substituted aryl;
each of R³ and R^{3′} is independently selected from hydrogen, alkyl, substituted alkyl, heteroalkyl, substituted heteroalkyl, aryl, and substituted aryl;
each of R⁴ and R^{4′} is a reactive group;
in the G-M-W side group:
G is selected from alkyl and substituted alkyl;
M-W is selected from alkyl and substituted alkyl;
W-G is selected from alkyl and substituted alkyl;
each of R¹⁵, R¹⁶, and R¹⁷ is each independently selected from hydrogen, alkyl, non-aryl substituted alkyl, heteroalkyl, non-aryl substituted heteroalkyl, or two of R¹⁵, R¹⁶, and R¹⁷ together with the carbon atom to which they are bonded form a cycloalkyl, non-aryl substituted cycloalkyl, cycloheteroalkyl, or non-aryl substituted cycloheteroalkyl ring;
n is an integer between 5 and 10000;
q is an integer between 1 and 10;
s is an integer between 1 and 10;
t is an integer between 1 and 10; and
v is an integer between 0 and 6.

2. The compound of claim 1, having the structure of Formula (II): 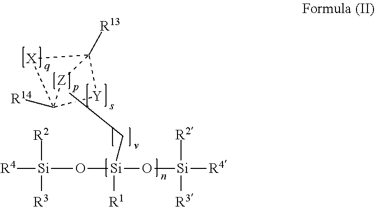
wherein
in the X-Y-Z side group:
X is selected from alkyl and non-aryl substituted alkyl;
Y is selected from alkyl and non-aryl substituted alkyl;
Z is selected from alkyl and non-aryl substituted alkyl;
or two of X, Y, or Z together with the carbon atom to which they are bonded form a cycloalkyl, non-aryl substituted cycloalkyl, cycloheteroalkyl, or non-aryl substituted cycloheteroalkyl ring;
q is an integer between 1 and 10;
p is an integer between 1 and 10;
s is an integer between 1 and 10; and
v is an integer between 0 and 6.

3. The compound of claim 2, having the structure of Formula (III): 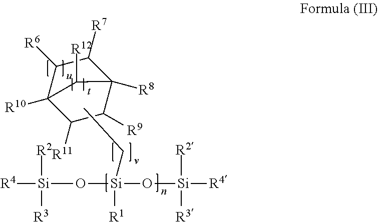
wherein
each of R⁶, R⁷, R⁸, R⁹, R¹⁰, R¹¹, and R¹² is each independently selected from hydrogen, alkyl, non-aryl substituted alkyl, heteroalkyl, and non-aryl substituted heteroalkyl;
u is an integer between 1 and 20;
t is an integer between 1 and 10; and
v is an integer between 0 and 6.

4. The compound of claim 3, wherein R⁶ is alkyl and R⁷, R⁸, R⁹, R¹⁰, R¹¹, and R¹² are hydrogen.

5. The compound of claim 3, wherein R⁶ is heteroalkyl and R⁷, R⁸, R⁹, R¹⁰, R¹¹, and R¹² are hydrogen.

6. The compound of claim 1, wherein the compound comprises more than one side group.

7. The compound of claim 1, comprising a structure selected from Formula (IV)-Formula (XVIII).

8. A cured silicone rubber comprising:
1-99% of a poly-N1, N2-siloxane polymer, wherein, on each separate silicon atom, N1 and N2 are each independently selected from the group consisting of substituted or unsubstituted methyl, ethyl, propyl, butyl, pentyl, hexyl, heptyl, octyl, nonyl, tetradecyl, octadecyl, phenyl, phenylethyl, and 3,3,3-trifluoropropyl; and
1-99% of a SGM polysiloxane copolymer comprising the compound of claim 1.

9. The cured silicone rubber of claims 8, wherein the SGM polysiloxane copolymer comprises a structure selected from Formula (IV)-Formula (XVIII).

10. The cured silicone rubber of claim 8, wherein the poly-N1, N2-siloxane polymer is polydimethylsiloxane (PDMS).

11. The cured silicone rubber of claims 8, comprising from 5 mol % to 50 mol % of the SGM polysiloxane copolymer.

12. The cured silicone rubber of claims 8, further comprising a filler material.

13. The cured silicone rubber of 12, wherein the filler material is selected from carbon black, fumed silica, and titanium dioxide.

14. A formulation comprising:
1-99% of the compound of claim 1; and
1-99% poly-N1, N2-siloxane polymer bearing the unsaturated moiety, wherein N1 and N2 are each independently selected from the group consisting of substituted or unsubstituted methyl, ethyl, propyl, butyl, pentyl, hexyl, heptyl, octyl, nonyl, tetradecyl, octadecyl, phenyl, phenylethyl, and 3,3,3-trifluoropropyl.

15. The formulation of claims 14, wherein the SGM polysiloxane copolymer comprises a structure selected from Formula (IV)-Formula (XVIII).

16. The formulation of claims 14, wherein the poly-N1, N2-siloxane polymer is polydimethylsiloxane (PDMS).

17. The formulation of claims 14, comprising from 5 mol % to 50 mol % of the compound of claim 1.

18. The formulation of claims 14, further comprising a curing agent having a thiol or a hydridosilane moiety.

19. The formulation of claims 18, wherein the curing agent is 1,3,5,7-tetramethyl-1,3,5,7-tetra(3-mercaptopropyl)cyclotetrasiloxane.

20. The formulation of claims 14, further comprising a catalyst.

21. The formulation of claims 14, further comprising a filler material.

22. A method of making a side group modified (SGM) polysiloxane copolymer comprising:
combining at least one SGM precursor, potassium hexamethyldisilazide, and a promotor to form a mixture, wherein the SGM precursor is a compound of claim 1;
polymerizing the at least one SGM precursor to obtain a SGM siloxane copolymer; and
functionalizing the SGM siloxane copolymer to form an SGM siloxane copolymer bearing an unsaturated moiety.

23. A method of making a cured silicone rubber comprising:
combining the formulation of claim 14 and a photoinitiator; and
applying ultraviolet or visible light radiation to the mixture at an ambient temperature.

24. An audio speaker comprising the cured silicone rubber of claim 8, operably linked to a diaphragm.

25. An apparatus comprising the audio speaker of claim 24.
